(19) United States
(12) Patent Application Publication
(10) Pub. No.: US 2014/0106008 A1
(43) Pub. Date: Apr. 17, 2014

(54) GLYCEROL COMPOSITIONS AND SOLUTIONS

(71) Applicant: Abraham Christo Venter, Berkshire (GB)

(72) Inventor: Abraham Christo Venter, Berkshire (GB)

(73) Assignee: BIO-ENERGY INGREDIENTS LIMITED, Surrey (GB)

(21) Appl. No.: 14/124,988

(22) PCT Filed: Jun. 21, 2012
(86) PCT No.: PCT/IB2012/053151

§ 371 Date: Dec. 9, 2013

(30) Foreign Application Priority Data
Jun. 24, 2011 (ZA) 2011/04716

(51) Int. Cl. A01N 31/02; A01N 59/06

(52) U.S. Cl. CPC A01N 31/02; A01N 59/06
USPC 424/682; 514/738

(57) ABSTRACT

The invention discloses the use of a treatment composition for preventing, or reducing, the production of contaminants selected from microorganisms and microorganism-produced toxins by contacting the substrate with the composition. The composition comprises a water glycerol mixture and calcium hydroxide in which the percentage by mass of glycerol in the water glycerol mixture is between 5% and 95%, at least some of the calcium hydroxide is dissolved in the water glycerol mixture and the concentration of the dissolved calcium hydroxide in the water glycerol mixture is at least 1.5 times higher than the maximum concentration of dissolved calcium hydroxide which can be obtained in water alone, thereby preventing or reducing the production of the contaminants. The extent of the prevention or reduction is at least 1.5 times more than the corresponding prevention or reduction produced by a treatment composition comprising water and calcium hydroxide only.

THIS INVENTION relates to glycerol compositions and solutions.

### FIELD OF THE INVENTION

The invention provides multi-functional liquid and solid potentiated glycerol compositions formulated to have potent anti-microbial (bactericidal, virucidal and fungicidal) and mycotoxin- and endotoxin-destroying properties and to have sterilizing, disinfecting, sanitising, preserving, detoxifying and decontaminating properties in addition to the beneficial properties of glycerol by combining glycerol on its own or in combination with suitable co-solvents with a glycerol-potentiating agent and optionally in combination with a co-potentiating agent or agents which are a source of solubilised hydroxyl ions wherein glycerol acts as a delivery system of the solubilised hydroxyl ions which have anti-microbial and mycotoxin destroying properties. The glycerol-potentiating agents or agents, which act synergistically with glycerol, are glycerol-soluble inorganic calcium hydroxide or calcium oxide salts or mixtures of calcium hydroxide or calcium oxide salts.

### BACKGROUND

Glycerol (CH₂OH.CHOH.CH₂OH), also known as glycerin, glycerine, propane-1,2,3-triol, 1,2,3-propanetriol, 1,2,3-trihydroxypropane, glyceritol and glycyl alcohol, is a colorless, odorless, hygroscopic, and sweet-tasting viscous liquid with high a solubility index in water. The name glycerol generally refers to the pure chemical substance and is commercially known as glycerine and the words “glycerol” and “glycerine” have been used interchangeably in the specification.

Glycerine is a material of outstanding utility with many areas of application. The key to glycerine's technical versatility is a unique combination of physical and chemical properties, ready compatibility with many other substances, and easy handling. Glycerine is also virtually non-toxic to human health and to the environment.

Physically, glycerine in its pure form is a water-soluble, clear, almost colorless, odorless, viscous, hygroscopic liquid with a high boiling point of 290° C. under normal atmospheric pressure. It is completely soluble in water and alcohols, slightly soluble in many common solvents for example ether and dioxane and is insoluble in hydrocarbons. Its specific gravity is 1.26 and molecular weight is 92.09 g.mole⁻¹

Chemically, glycerine is a trihydric alcohol, capable of being reacted as an alcohol yet stable under most conditions. With such an uncommon blend of properties, glycerine finds applications among a broad diversity of end uses in the manufacture of numerous domestic, industrial, agricultural and pharmaceutical products. In some, glycerine is the material of choice because of its physical characteristics, while other uses rely on glycerine's chemical properties. Glycerine has over 1500 known end uses. Major, or large volume applications include some dozen different categories that range from foods to urethane foams.

Glycerine plays an important role in nature and is closely linked to the life processes themselves, being a component of all living cells. It occurs naturally in wines, beers, bread, and other fermentation products of grains and sugars. Glycerine is found abundantly in nature in the form of triglycerides, the chemical combinations of glycerine and fatty acids, which are the principal constituents of almost all vegetable and animal fats and oils.

Industrially, glycerine is a product of fats and oils that have been saponified, hydrolysed, or transesterified, which is recovered in a crude state and then purified by distillation or ion exchange.

Biodiesel can be produced from vegetable oils or animal fats by trans-esterification using an alcohol and a base, and glycerine is produced as a by-product of the production. Commonly, the vegetable oil or animal fat is reacted with an alcohol such as methanol in the presence of a base such as sodium hydroxide or potassium hydroxide, or the corresponding methoxide. Biodiesel can be produced in a single stage or a two-stage reaction process but, in either process, one of the by-products is glycerol, which constitutes about 10% by weight of the total weight of the product. The glycerol is usually separated from the biodiesel by settling prior to washing the biodiesel with water. The by-product glycerol from this process is impure and contains unreacted methanol, sodium or potassium salts, water and other impurities caught up in the settling process. This glycerol is accordingly an undesirable by-product of the production of biodiesel and very large quantities of glycerol are produced in the biodiesel industry globally.

The biodiesel industry has been searching for economically viable used for the by-product glycerine for a number of years. In addition, glycerol derived from other sources often contains water and other impurities. Glycerine is also synthesized from propylene and can also be produced by fermentation or hydrogenolysis of carbohydrates, but these routes currently are not utilized industrially. Glycerine, whether recovered from triglycerides or synthesized, is almost always consumed as a refined or purified substance. Glycerine's versatility is a tribute to its unique combination of chemical and physical properties.

Chemically, glycerine is a trihydric alcohol which is very stable under most conditions, but which can be reacted to form many derivatives. Physically, it is a clear, almost colorless, viscous, high-boiling liquid miscible with water and alcohol, and like these materials, a good solvent. At low temperatures, glycerine tends to supercool, rather than crystallize. Water solutions of glycerine resist freezing, a property responsible for glycerine's use as an anti-freeze in cooling systems. Among its most valuable attributes are hygroscopicity, or the ability to absorb moisture from the atmosphere, and low vapor pressure, a combination that produces outstanding permanent humectancy and plasticity.

Glycerol is used very extensively in the pharmaceutical industry. Because of its valuable emollient (making soft, supple or soothing) and demulcent (having a softening or soothing effect) properties, glycerol is an important ingredient in innumerable pharmaceutical and cosmetic preparations. Glycerine is used as a solvent in the preparation of tinctures. It is used in the preparation of Elixirs, such as Theophylline, which is used to treat respiratory conditions, such as asthma and bronchitis. As a humectant, glycerol constitutes an important pharmaceutical ingredient to prevent the drying out of preparations, particularly ointments and creams. Since it is a sweet-tasting liquid it is used as a sweetening agent to impart sweetness to a preparation. It is used as a levigating agent to reduce the particle size of a drug powder. Due to its preservative qualities, it is used as a stabilizer and an auxiliary solvent in conjunction with water or alcohol. Glycerol is also used in the pharmaceutical industry to extract and prevent inert materials from precipitating upon standing. It is used as a plasticizer to enhance the spread of the coat over tablets, beads and granules. The smoothness of lotions, creams and toothpaste is due to the presence of glycerol.⁹

Glycerine is virtually non-toxic in the digestive system and non-irritating to the skin and sensitive membranes, except in very high concentrations when a dehydrating effect is noted. It is also odourless and has a warm, sweet taste.

Some of glycerine's uses depend on its chemical properties, one such example being the manufacture of urethane polymers. Others make use of one or more of its physical characteristics, such as toothpaste and moisturising cream. Quite often, however, the choice of glycerine in either type of application may depend upon secondary factors such as virtual non-toxicity and freedom from disagreeable odour or taste. Esters used as food emulsifiers are outstanding examples of chemical applications for glycerine where non-toxicity of reactants is essential. Similarly food wraps and bottle cap liners in intimate contact with food and beverages require a plasticizer-humectant that cannot be a source of contamination and hence glycerine is a common choice.

The ability to meet a non-toxicity requirement plus the availability of bonus properties in addition to those associated with its principal function in a product makes glycerine a prized ingredient among chemists and formulators.

In a hand cream, for example, glycerine may be incorporated as an ingredient because of its outstanding humectancy. Simultaneously, glycerine's emollient qualities may improve the efficacy of the formulation, its viscosity may give the product a very desirable body, its anti-freeze qualities may afford necessary protection in shipping and storage—all in addition to the main function of maintaining the moisture content of the product at the proper level.

Glycerine possesses a unique combination of physical properties. Although chemical reactivity and versatility make glycerine one of the basic building blocks of the chemical industry, each year large volumes go into non-chemical uses. In these processes and products, glycerine's function as a plasticizer, humectant, solvent, bodying agent, lubricant, etc. is based on one or more of its physical properties. Generally, no chemical combination should take place in such applications. Chemical stability is therefore a prerequisite in the choice of a material to impart specific physical properties. Glycerine meets this requirement, for it is highly stable under ordinary conditions of storage and use, remaining free from objectionable colour, odour or taste over time.

Hygroscopicity, the ability to attract moisture from the air and hold it, is one of the most valuable properties of glycerine. It is the basis for its use as a humectant and as a conditioning agent in many applications where both the glycerine and the water it holds act as plasticizers. The net effect is to give products the desired softness, flexibility, creaminess and shelf life.¹

Glycerine is soluble and mixes readily in all proportions with water, alcohol, and chloroform. It increases the density of the mixture and lowers the freezing point. The great variety of substances it is capable of dissolving, places glycerine next to water as a medium for solutions. The virtual non-toxicity of glycerine as an ingredient in pharmaceuticals and foods has been established through generations of safe use and by supporting data.

Glycerine occurs naturally in foods, both in a combined form as in fats and in a free state as in fermentation products like beer and wine. With a diet of 100 grams of fat per day, the human body would absorb and metabolize 10 grams of glycerine as glycerides. When metabolized, glycerine yields roughly the same caloric food value as glucose or starch.¹ Glycerol is an important moistening agent for baked goods. It is also added to candies and icings to prevent crystallization. Glycerol is used as a solvent for food colours and a carrier for extracts and flavouring agents.⁹

Glycerine was initially accorded GRAS status (Generally Recognized As Safe) as a miscellaneous substance by the U.S. Food and Drug Administration (FDA) in 1959. Subsequently, in 1961, it was reclassified as a miscellaneous and general-purpose food additive. Under a regulation the FDA promulgated in 1977, it was reclassified and recodified as a multiple purpose GRAS food substance. Glycerine was also first listed as GRAS as a substance migrating to food from paper and paperboard products used in food packaging in a regulation published in 1961. Glycerine is listed as GRAS in the Code of Federal Regulations (CFR) as a multiple purpose GRAS food substance (21CFR 182.1320) and as a substance migrating from paper and paperboard products: (21CFR 182.90) for use in certain food packaging materials.

The FDA proposed reaffirmation of glycerine as GRAS as a direct human food ingredient in February 1983 as part of a comprehensive review of human food ingredients classified as GRAS or subject to prior sanction. There has been no official FDA action with respect to the proposed reaffirmation of the GRAS status of glycerine since it was promulgated. The FDA review of the GRAS list is, by its very nature, a lengthy procedure and one that involves many food ingredients.

Glycerol is also virtually non-toxic to the environment, which is another plus factor with respect to ordinary plant operations and the kinds of problems usually associated with accidental spills. Its aquatic toxicity is insignificant. Glycerine's TLm96 value, or the concentration that will kill 50% of the exposed organisms in 96 hours, is over 1000 mg/litre. Glycerine may be used on every part of the epidermis, including mucous membranes. When diluted to a concentration below 50% it acts as an emollient and demulcent, finding important applications in ointments and lotions. Preparations for the most sensitive areas of the body are commonly made of water-soluble bases compounded with glycerine.

Glycerine is one of the most widely used ingredients in medical prescriptions. Only water may exceed glycerine in its range of applications. A predominantly sweet taste producing a pleasant sensation of warmth in the mouth is another of glycerine's assets. Studies have shown that it is from 55 to 75 percent as sweet as sucrose, with the relative sweetness depending on the concentration tested. As a sweetening agent, glycerine makes many medicinal preparations palatable, which ordinarily would be unpleasant or less pleasant to swallow. In cough remedies, for example, it makes the mixture more pleasing to the taste while simultaneously soothing the mucous membranes.

In such products as dentrifices and chewing gum, glycerine imparts a desirable degree of sweetness without clashing with the other flavour elements. Perfumes or flavours remain “true to type,” with no fragrance or flavour change resulting from the presence of glycerine. It also tends to offset the harshness or bite of alcoholic (ethyl) content.¹

Glycerine is used as a preservative. In foods and beverages, glycerine functions as a humectant, solvent, sweetener, and preservative. It acts as a solvent for flavours and food colours in soft drinks and confections and as a humectant and softening agent in candy, cakes, and casings for meats and cheese. Glycerine is also used in dry pet foods to help retain moisture and enhance palatability.¹

Modern animal nutrition is continuously searching for greater efficiencies and this requires increased value and use from the various feed ingredients available. Some feed ingredients have useful properties in feed manufacture and animal performance in addition to their conventional nutrient values. Such ingredients are now described as “Functional Feed Ingredients.”

Crude glycerine from the biodiesel industry already has many applications in animal nutrition as a conventional feed ingredient. Glycerol may improve feed hygiene by inhibiting mould growth⁶. It is able to replace up to 10% of rapidly fermentable carbohydrates in ruminant diets⁶ and up to 20% has been incorporated into finishing lamb diets.³

In monogastric diets glycerol is also a useful energy source. Lactating sows fed diets containing up to 9% crude glycerol performed similarly to sows fed a standard maize/soyabean meal diet.⁵ When up to 10% glycerol was fed to growing pigs, there were no effects upon pig growth rates, feed intake or gain:feed ratios.⁴ A level of 5-10% glycerol was beneficial to broiler performance in terms of weight gain, feed intake and feed conversion ratio⁷.

Glycerol from biodiesel production was used by Cerrate et al., (2006)² as an energy source in broiler diets formulated to meet typical commercial standards. Glycerol was assigned a metabolizable energy value of 14.6 MJ/kg (3527 kcal/kg) in formulating the diets. Birds fed diets with 5% glycerol did not differ significantly in performance from birds fed the control diet with no glycerol. Breast yield as a percent of the dressed carcass was significantly greater for birds fed diets with 2.5 or 5% glycerol as compared to those fed the control diet with no glycerol. These data indicate that glycerol from biodiesel can be a useful energy source for use in broiler diets.⁶

As a precursor of glucose, glycerol can increase milk yield, improve lactose excretion, reverse ketosis and reduce the risk of conditions secondary to ketosis in dairy cows. It also increases water intake and feed efficiency. Glycerol also acts as a pellet binder and acts as a lubricant when pelleting feed. Previously published research and recent work completed at Purdue University indicate the value of glycerol as a feed for lactating dairy cattle. Increased production of biodiesel and resulting glycerol when combined with an increased demand for corn in ethanol production may warrant the use of glycerol as livestock feed. Although issues exist relative to the composition of crude glycerol, there does not appear to be any detrimental impact of feeding glycerol up to at least 15% of the total ration dry matter¹⁰. Glycerol clearly has value as a feed ingredient for a wide range of animal species as an energy source.

Glycerine has been reported to have bacteriostatic (slows the growth of bacteria) and limited bactericidal (kills bacteria) effects at various concentrations against Pseudomonas aerugi nosa, Escherichia coli, Salmonella typhimurium and Staphylococcus aureus. A positive correlation was found between the bacteriostatic and bactericidal concentrations of glycerine against these organisms.⁸

The field for employment of glycerine is wide and diverse. Although it has already found many applications, the many important properties it possesses guarantee a still wider scope for future uses. Potentiated glycerol falls into this category. The Applicant has found that glycerol can be potentiated by the accumulation of hydroxyl ions in a stable solution. The potentiated liquid glycerol consequently becomes an effective delivery system or carrier for solubilised hydroxyl ions, which have powerful anti-microbial and mycotoxin-destroying effects.

It is the hydroxyl ion in solution that is the effective, active anti-microbial and mycotoxin-destroying agent, the efficacy of calcium hydroxide in aqueous solution is therefore limited. However, calcium hydroxide is significantly more soluble in glycerol and glycerol-water mixtures with high glycerol content. It is therefore possible to prepare a solution in glycerol medium with a much higher concentration of solubilised hydroxyl ions compared to water, and by doing this the efficacy of the completely solubilised calcium hydroxide is significantly higher than in the absence of glycerol. It is the combination of water, glycerol and base which produces a solution having a much higher concentration of base than would be possible in the absence of the glycerol which produces the “potentiated glycerol” of the invention. It is therefore possible to reduce the dose for example in compound feed where space in the formulation is very restricted. It is also possible to for example make a concentrated solution and sell or ship this and the solution concentrate can be diluted to desired or optimal concentration and viscosity at point of use since it is more expensive to ship water or diluted solutions or it can be used as a potent concentrate as it is in certain applications. The invention pertains to solutions, wherein the hydroxyl ions are in solution.

As a further aspect of the invention the treatment agent may be in solid form for example powders, granules or flakes and the like containing both calcium and glycerol and from which both calcium hydroxide and glycerol is released in solution when the solid material is exposed to water and wherein the solubility of the hydroxide is enhanced in a similar way than in the case of solutions by the simultaneous release of glycerol in the moisture from the solid material. The solid material may also be provided for example as a suspension, slurry, paste and the like in water or the calcium hydroxide and glycerol in solution may be extracted from the solid calcium-glycerol material to provide a solution.

The solid calcium-glycerol material may be prepared either exothermically from calcium oxide and wet glycerol as described in PCT/IB2009/052931 or non-exothermically for example by mixing calcium hydroxide with glycerol followed by an optional drying step for example a heat drying step or a vacuum drying or air drying step. In both cases the same mechanism applies i.e. the release of calcium hydroxide and glycerol in solution when the solid material is contacted with moisture on a substrate for example an animal feedstuff or on exposure to excess water which results in the enhanced solubilisation of the hydroxide in the aqueous medium which in its turn enhances the anti-microbial, anti-mycotoxin and anti-endotoxin efficacies of the solubilised hydroxyl ion in comparison to calcium hydroxide in a glycerol free medium.

The purpose of potentiated glycerol therefore is to combine the existing beneficial properties of glycerol in one product with the advantages that potentiation brings i.e. potent anti-microbial (bactericidal, fungicidal, virucidal) and mycotoxin-destroying functions combined in one versatile, multi-functional product and simultaneously enhance the efficacy of for example calcium oxide and/or calcium hydroxide, which are poorly soluble in water, in aqueous glycerol solution through an enhanced solubilisation effect and thus exploiting glycerol as vehicle or carrier system for optimal delivery of hydroxyl ions to the substrate.

The Applicant is also of the view that glycerol potentially increases microbial cell membrane permeability of the metal cations and associated hydroxyl ions and thus increases the passage of the ions inside the microbial cells.

An additional benefit of the glycerol-potentiating agent synergism is the enhanced treatment agent-substrate contact effect, which is facilitated by the “hydrophilic stickiness” of glycerol.

This may result in prolonged hydroxyl-substrate contact times and thus enhanced anti-microbial and mycotoxin-destruction efficacies compared to the salt in water medium in the absence of glycerol.

In summary, there are a number of additional benefits of the presence of glycerol as a carrier or delivery system for calcium hydroxide and/or calcium oxide when a substrate is treated with an aqueous solution thereof containing glycerol (for example spraying of macro feed ingredients such as grains) as opposed to solutions not containing glycerol:
1. Increased contact or “dwell” time of the potentiated glycerol treatment agent on the substrate through “stickiness” and viscosity facilitated by the presence of glycerol in the solution and thus results in increased anti-microbial and mycotoxin destructing efficacy of the solution against microbes and toxins present on the substrate.
2. Increased absorption of the calcium hydroxide present in the solution into the substrate facilitated by the solvent properties of the added glycerol and hence also efficacy against microbes and toxins directly beneath the outer surface area/membrane of the substrate.
3. Glycerol is hygroscopic and a known humectant acting as a wetting agent and hence retaining moisture on and attracting moisture to the substrate surface area. It therefore prevents the substrate from drying out, and thus enhances the solubilisation and thus anti-microbial and anti-toxin action of the solubilised hydroxyl ions over a longer period of time on the substrate as the substrate stays moist for longer due to the presence of the glycerol coating.
4. Glycerol is not volatile (low vapour pressure) and has a high boiling point compared to water. This feature also helps the calcium salt containing coating to remain on the substrate much longer than when applied in water, especially under warm, dry treatment conditions where moisture evaporates quickly and leaves the dry, non-solubilised (non-active) calcium salt powder behind. At low temperature spraying conditions on the other hand the glycerol containing solution remains fluid to enable spraying of the cold, non-frozen solution and also prevents crystallization and hence deactivation of the solution.
5. Glycerol is known to prevent inert materials from precipitating upon standing. It thus acts as a plasticiser to enhance the effective spreading of the hydroxyl active containing coating evenly over substrate particles.
6. Increased permeation of the solubilised hydroxyl ion active into microbial cell walls due to the extended contact or “dwell” time thereof on the substrate and hence increased anti-microbial and anti-toxin efficacy. It is known that glycerol “can break down cell walls to extract soluble proteins, since it tends to form stable association with proteins liberated, probably because of the “presence of the hydroxyl groups in glycerol molecule.” It is also reported that “glycerol has long been known to penetrate rapidly into bacteria”. It has also known that the microbial cell membrane is semi-permeable, or rather selectively permeable. Glycerol penetrates the membrane readily, glucose penetrates poorly, sucrose very poorly, and sodium chloride is almost non-penetrating.
7. Glycerol is reported to be bacteriostatic and a preservative in its own right. These properties therefore would complement and enhance the anti-microbial and anti-toxin action of the solubilised calcium salts therein.
8. In the case of compound feed applications, glycerol acts as a lubricant and friction reducing agent as well as a dust suppressant and thus would enhance the pelletising efficiency of the feed.
9. Glycerol is a precursor to glucose as source of energy when added to the treated substrate for example animal feed, is non-toxic, easily digested and increase palatability (sweet taste) of feed substrates.

### DETAILED DESCRIPTION OF THE INVENTION

It is an object of the invention to provide a composition wherein glycerol with its described useful properties in various applications can be combined with the anti-microbial and toxin destroying properties of solubilised hydroxide ions in liquid compositions and solid compositions which release solubilised calcium hydroxide in aqueous medium thereby potentiating the glycerol as an effective delivery system of the potent anti-microbial and toxin-destroying solubilised hydroxyl ions and consequently create a potent sterilant, decontaminant and preservative agent to efficiently destruct toxins for example mycotoxins and endotoxins, kill micro-organisms and/or inhibit microbial growth and prevent for example further mould growth, mycotoxin formation through mould growth and bacterial growth in for example food, feeds and in feed materials.

Through the potentiation of glycerol, a synergistic relationship is established between glycerol as a delivery system with its own beneficial properties and the potentiating agent or agents, the source of the solubilised hydroxyl ions. The net result is a multi-functional product wherein the individual components are in a synergistic relationship with each other, i.e. wherein the combined beneficial effects of the components of the potentiated glycerol composition significantly exceeds the sum of the individual beneficial effects of glycerol on the one hand and the anti-microbial and toxin-destroying properties of the potentiating agent or agents on the other hand. (Synergism is defined as the joint action of agents so that their combined effect is greater than the sum of their individual effects.)

Potentiated glycerol is a versatile, multi-purpose product which combines the known properties of glycerol with the additional anti-microbial and toxin-destructing functions combined in one product which reduces the need for utilising different products to fulfill the separate functions as required in various application areas.

Initial in vitro tests conducted at a major contract research laboratory in the UK have indicated that potentiated glycerol solutions have potent anti-pathogenic bacterial activity against Salmonella enterica abony and Campylobacter jejuni. Potentiated glycerol solutions have for example demonstrated strong anti-microbial activity when tested neat and at dilutions down to at least 1/32 against Salmonella enteric abony and Campylobacter jejuni, respectively, with no bacterial counts observed (Examples 1 and 2).

Positive results have also been obtained in a leading laboratory specializing in fruit science using potentiated liquid glycerol to control Monilinia mould, which causes brown rot in fruit as well as Botrytis and Penicillium mould species (Example 3).

The efficacy of liquid and solid potentiated glycerol formulations to reduce the mycotoxin concentration of a multi-toxin aqueous solution containing aflatoxin B1 (AFB1), ochratoxin A (OTA), zearalenone (ZEA), fumonisin B1 (FB1), deoxynivalenol (DON), and HT-2/T-2 toxins (HT-2/T-2) has also been show (Examples 4 and 5).

Positive results have also been obtained in a leading laboratory specializing in biofilm science using potentiated liquid glycerol to control biofilms of Staphylococcus aureus, Pseudomonas aeruginosa and Candida albicans (Example 6) and Salmonella enteric abony.

Potentiated glycerol kills mycotoxin-producing fungi and inhibits further mould growth and hence new mycotoxin formation, as does for example propionic acid, but unlike propionic acid the same product also destructs mycotoxins.

Potentiated glycerol is therefore multi-functional as it works as a mould growth inhibitor and kills existing moulds. However, it also has the added advantage of working as an existing mycotoxin-destructing agent. It is therefore a superior product compared to current products on the market as it prevents new mycotoxin formation (through mould kill and prevention of new mould growth) and also chemically destructs existing mycotoxins at the same time.

Potentiated glycerol may be added to compound feed to reduce the risk of contamination from feed-borne microbes such as Salmonella. This is of importance to producers of broiler, turkey and poultry breeder feed where the costs of Salmonella contamination are high. Unlike some materials currently used, potentiated glycerol is not hazardous to use in a feed mill and its high-energy contribution may be taken into account by nutritionists in feed formulation.

Destruction of feed quality either by pathogenic bacteria or by mycotoxins produced from mould growth is an extremely important issue in terms of feed and food safety. The use of a functional feed ingredient such as potentiated glycerol will stabilise co-products from the biofuels industry and play a valuable role in helping to improve feed safety and hygiene. This technology will be of significant benefit to the biofuels industry by enhancing the value of co-products and thereby lowering net production costs. The animal feed Industry will also benefit by having access to a new functional feed ingredient of high nutritional value that is easy to transport, to store and to use in feed manufacture.

In general potentiated glycerol can be used in any animal feed or feedstuff, which has to be stored and may come into contact with moisture. It is particularly useful in areas of high temperature and humidity where microbial spoilage is a problem. It is active against bacteria, yeasts, moulds, endotoxins and mycotoxins and may also be virucidal.

Potentiated glycerol therefore has many applications as a sterilant, decontaminant and preservative agent in both animal feeds and in human foods, for example in fruit, vegetable and meat treatments. It is an attractive multi-functional ingredient as the constituents of the product are already recognized for use in feed and food. Potentiated glycerol is not light sensitive, is chlorine free, has very little odour and is not difficult to handle or apply.

Potentiated glycerol is a valuable feed ingredient and is suitable as an energy source for all species; cows, sheep, pigs and poultry.

Glycerol can thus be potentiated by combining it with calcium hydroxide, calcium oxide or a mixture of these salts with the optional inclusion of other metal salts.

The use of calcium hydroxide is preferred above calcium oxide in order to avoid exothermic reaction conditions when mixing the potentiating components with wet glycerol. The solutions or concentrates pre-dilution may optionally be filtered depending on solubility characteristics of the selected salt or salt combinations in glycerol medium to provide clear solutions wherein all the components are completely dissolved in the glycerol carrier and wherein the hydroxyl ions are completely solubilised in order to achieve the maximum efficacy as anti-microbial and mycotoxin-destroying agents.

The first object of the invention is thus to provide clear, liquid potentiated glycerol solutions and pre-dilution concentrates with optimal efficacy as opposed to compositions such as slurries, pastes and the like wherein the components of the mixtures are not in solution but, for example, in suspension.

The first object in practical terms is to provide solutions for application onto substrates through, for example, spraying, dipping, misting, painting or mixing and the like so that no undesired visible residues of non-solubilised potentiating agent will not be left on the surface of the treated substrate, for example on fruit or meat carcasses, and to avoid blockages in devices used for spraying, misting and the like.

The potentiated glycerol solution can, for example, be prepared as a clear, viscous concentrate of the potentiating agent or agents in glycerol alone or in mixtures with co-solvents with lower viscosity than glycerol for example water and ethanol in order to mechanically improve mixing and optional filtration thereof and be transported as such, before being diluted with non-viscous solvents for example water or ethanol or mixtures thereof to provide non-viscous, clear solutions with the appropriate concentrations of glycerol and hydroxyl ions to meet the practical requirements for application as well as the appropriate concentration of hydroxyl ions in solution depending on, for example, the microbial load and/or the toxin concentration or type and contact time per substrate and desired outcome, for example sterilization only versus sterilization plus longer-term preservation need.

As a further aspect of the invention the treatment agent may be in solid form for example powders, granules or flakes and the like containing both calcium and glycerol and from which both calcium hydroxide and glycerol is released in solution when the solid material is exposed to water and wherein the solubility of the hydroxide is enhanced in a similar way than in the case of solutions by the simultaneous release of glycerol in the moisture from the solid material. The solid material may also be provided for example as a suspension, slurry, paste, emulsion and the like in water or the calcium hydroxide and glycerol in solution may be extracted from the solid calcium-glycerol material to provide a solution.

The solid calcium-glycerol material may be prepared either exothermically from calcium oxide and wet glycerol as described in PCT/IB2009/052931 or non-exothermically for example by mixing calcium hydroxide with glycerol followed by a heat drying step or a vacuum drying or air drying step. In both cases the same mechanism applies i.e. the release of calcium hydroxide and glycerol in solution when the solid material is contacted with moisture on a substrate for example an animal feedstuff or on exposure to excess water which results in the enhanced solubilisation of the hydroxide in the aqueous medium which in its turn enhances the anti-microbial, anti-mycotoxin and anti-endotoxin efficacies of the solubilised hydroxyl ion in comparison to calcium hydroxide in a glycerol free medium.

The Applicant is of the view that the additional benefits of the synergistic relationship between glycerol and potentiating agent include, for example, the potential increase in microbial cell membrane permeability of the metal cations and hydroxyl ions facilitated by glycerol thus increasing and facilitating the passage of the ions inside the microbial cells. An additional benefit of the glycerol-potentiating agent synergism is the enhanced treatment agent-substrate contact through the “hydrophilic stickiness” of the agent facilitated by the glycerol which results in enhanced hydroxyl-substrate contact or “dwell” times and thus enhanced efficacies compared to the salt in water medium in the absence of glycerol.

Potentiated glycerol also functions in pelleting as a lubricant and pellet softener. This is important in for example piglet feed where hard pellets can be produced due to the lactose content.

Calcium hydroxide is a very suitable glycerol-potentiating agent due to its approved status for use in feed and food, its anti-microbial, endotoxin- and mycotoxin-destroying properties and synergistic action in combination with glycerol, thereby complementing, amplifying and optimizing the range of beneficial functions of the individual substances in various applications.

The efficacy of calcium hydroxide or calcium oxide as a clear, aqueous solution is limited due to its poor solubility in water and thus availability of solubilised hydroxyl ions in this medium. On the other hand, these calcium salts are unpleasant to handle in the solid form. Also, aqueous suspensions of these salts are also difficult if not impossible to apply for example by spraying or misting. The solubility of calcium hydroxide in water ranges from 0.185 gram per 100 ml water (0.185% w/w) at 0° C. and 0.173 gram per 100 ml (0.173% w/w) at 20° C. to 0.071 gram per 100 ml water (0.071% w/w) at 100° C. (the solubility decreases with an increase in temperature). The use of calcium hydroxide as glycerol-potentiating agent is preferred to calcium oxide, as the oxide reacts exothermically with the aqueous medium thereby generating heat. The rise in temperature leads to a reduced solubility of the salt and hence a reduced solubilised hydroxyl ion concentration compared to using calcium hydroxide as potentiating agent.

Calcium hydroxide is significantly more soluble in glycerol, glycerol-water mixtures, sucrose, fructose, maltose and mixtures thereof. Glycerol is most preferred as in aqueous medium at high concentration, as sugar precipitates whereas the glycerol does not. For example in a glycerol-water mixture with a glycerol:water ratio of 35:65 (w/w), the solubility of the calcium hydroxide increases to 1.3 gram per 100 ml (1.3% w/w) at 25° C.¹³ As a general rule, about 10% (w/w) to about 80% (w/w) glycerol is the most effective working range. Below about 40% (w/w) glycerol, relatively large increments of glycerol yield relatively small improvements in calcium hydroxide solubility. In the range of 40% to 80% (w/w) the solubility increases approximately linearly with glycerol addition. No improvement in calcium hydroxide solubility is achieved above about 80% (w/w) glycerol.^{14,15}

The increase in solubility of a commercial grade of calcium hydroxide powder in water at room temperature by the addition of various amounts of glycerol as tested in our laboratory is depicted in Table 1.

In each instance an excess (3% w/w) commercial grade calcium hydroxide powder was mixed with distilled water at room temperature for 90 minutes and the resulting white suspension filtered to provide a clear solution. It was observed that the clear, saturated solutions of calcium hydroxide in glycerol and glycerol-water mixtures were stable on standing at room temperature over time, whereas a fine precipitation of calcium hydroxide was observed on standing at room temperature of the initially clear, saturated calcium hydroxide solution in glycerol-free water.

TABLE 1
Analysis of clear, filtered solutions of calcium hydroxide in water and
glycerol-water mixtures at room temperature

| | | | | Solubility |
|---|---|---|---|---|
| | Solubilised | Solubilised | Solubilised | increase with |
| Glycerol | Ca(OH)₂ | Ca | OH | glycerol |
| (% w/w) | (% w/w) | (% ww) | (% w/w) | addition |
| 0 | 0.167 | 0.09 | 0.077 | — |
| 10 | 0.333 | 0.180 | 0.153 | 1.99 |
| 20 | 0.610 | 0.330 | 0.28 | 3.65 |
| 30 | 0.833 | 0.450 | 0.383 | 4.99 |
| 60 | 2.330 | 1.260 | 1.071 | 13.95 |
| 82 | 2.609 | 1.410 | 1.199 | 15.62 |

The anti-microbial and toxin-destructing efficacies of calcium hydroxide are significantly enhanced when it is combined with glycerol or glycerol-water medium due to the increased solubility thereof in the glycerol medium compared with water. At the same time the glycerol is potentiated by the salt with the resulting effect that the beneficial properties of the solubilised salt complement the beneficial properties of glycerol which in turn acquires anti-microbial as well as toxin-destructing functions in one versatile, multi-functional product. As a further advantage in addition to this beneficial synergistic relationship between glycerol and calcium salt, the potentiated glycerol which contains solubilised calcium hydroxide as potentiating agent is also a source of bio-available calcium, which is for example an advantage for use in animal feed and as a fruit treatment agent.

The in vitro testing of a range of potentiated glycerol solutions and controls against representative pathogenic bacteria of interest, Salmonella enterica abony and Campylobacter jejuni is set out in Examples 1 and 2.

A very potent, highly anti-microbial and mycotoxin destroying, low-viscosity, sprayable potentiated glycerol solution has for example been prepared through the use of sodium hydroxide and calcium hydroxide solubilised in glycerol-water with a glycerol content of 29.2% (w/w). This provided after filtration a clear, stable potentiated glycerol solution with a total solubilised hydroxyl ion concentration of 1.92% (w/w).

Initial in vitro tests conducted at a major contract research laboratory in the England indicated that clear, filtered potentiated liquid glycerol solutions demonstrated superior anti-bacterial activity compared to a clear, filtered, saturated calcium hydroxide solution, which was tested as reference. All tests were performed in duplicate.

A clear, filtered, saturated calcium hydroxide solution in water with a maximum soluble hydroxyl ion concentration of 770 mg/kg (0.077% w/w) demonstrated strong anti-microbial activity against Salmonella enterica abony when tested neat, with no bacterial counts observed. However, the 1/2 dilution demonstrated only moderate anti-microbial activity reduced from the order of 10⁶ to 10³ colony-forming units (cfu) per ml. A 3/8 dilution demonstrated weak anti-microbial activity, with the test organism reduced from the order of 10⁶ to 10⁵ colony-forming units (cfu) per ml (Example 2).

The same saturated, aqueous, glycerol-free calcium hydroxide solution demonstrated a strong anti-microbial activity when tested neat and at dilutions of 1/2 and 1/4 against Campylobacter jejuni. However, the 1/8 and 1/16 dilutions demonstrated only weak anti-microbial activity with the microbial counts reduced from the order of 10⁶ to 10⁵ cfu per ml (Example 1).

The wet glycerol co-product from biodiesel production which has been used as co-solvent for calcium hydroxide had a limited bactericidal activity against Campylobacter jejuni (Example 1). The same glycerol sample did however not show any effect against the more resistant Salmonella enetrica abony organism (Example 2).

A solution of 80% (w/w) salt-free glycerol in water as second reference demonstrated no anti-microbial activity against Salmonella enterica abony when tested neat or at any dilution. All the clear, filtered potentiated glycerol solutions were however proven to be superior in bactericidal action compared to the glycerol-free calcium hydroxide solution at its maximum hydroxyl ion solubility level.

A potentiated glycerol solution with a glycerol concentration of 30% (w/w) and a hydroxyl ion concentration of 0.383% (w/w) demonstrated strong anti-microbial activity against Salmonella enterica abony when tested neat and at 1/2 and 1/4 dilutions against the test organism, with no bacterial counts observed. At the 1/8 dilution, anti-microbial activity was also observed, with the test organism reduced from the order of 10⁶ to 10⁴ colony-forming units (cfu) per ml. Very weak anti-microbial activity was observed at the 1/16 dilution and no anti-microbial activity was observed at the 1/32 and 1/64 dilutions (Example 2).

The same potentiated glycerol solution with a glycerol concentration of 30% (w/w) and a hydroxyl ion concentration of 0.383% (w/w) demonstrated strong activity against Campylobacter jejuni when tested neat and at 1/2, 1/4, 1/8 and 1/16 dilutions against the test organism, with no bacterial counts observed. At the 1/32 dilution, anti-microbial activity was also observed, with the test organism reduced from the order of 10⁶ to 10³ colony-forming units (cfu) per ml. Some anti-microbial activity was observed at the 1/64 dilution, with the test organism reduced from the order of 10⁶ to 10⁵ colony-forming units (cfu) per ml (Example 1).

A potentiated glycerol solution with a glycerol concentration of 29% (w/w) and a hydroxyl ion concentration of 1.1% (w/w) demonstrated strong anti-microbial activity against Salmonella enterica abony when tested neat and at 1/2, 1/4, 1/8, 1/16 and 1/32 dilutions against the test organism, with no bacterial counts observed (Example 2).

Currently, hazardous liquid substances such as formaldehyde, formic acid and propionic acid are tolerated in the animal feed industry as anti-microbial agents in doses of about 0.4% (w/w) i.e. about 4 kg per tonne feed. These agents have no or little effect on mycotoxins.

A glycerol-free solution of calcium hydroxide in water is not efficient enough to be used as a benign replacement for these hazardous chemicals. However, appropriately formulated, multi-functional solid and liquid potentiated glycerol compositions are safe and pleasant to use, almost odourless, stable and can compete effectively against the currently used unpleasant substances, with the added advantage of toxin-destructing capability as well as energy contribution from the glycerol. These potentiated glycerol compositions therefore represent an important new generation of versatile, multi-functional agents, which set them apart from the unpleasant agents currently used commercially which only act as anti-microbial agents without the added toxin-destruction function.

The uses for potentiated glycerol compositions include, but are not limited to, food and animal feed applications for example as anti-microbial (bactericidal and/or fungicidal and/or virucidal) and/or toxin-destructing (mycotoxins and/or endotoxins) agents acting in combination with various substrates.

The quality of animal feeds and human foods is continuously threatened by the presence of pathogenic bacteria such as Salmonella and Campylobacter, by the growth of moulds and by the subsequent production of mycotoxins.

The problems associated with contamination of animal feed with pathogenic bacteria for example Salmonella, Campylobacter and E. coli species are well documented in the literature.^{16,20}

Interventions to reduce pathogen contamination of feed include thermal, chemical, and irradiation treatments. Salmonella is inactivated during pelleting of poultry feeds at temperatures exceeding 83° C., but some time/temperature combinations (50-70° C., 20-600 s) used in commercial pelleting processes of cattle feed are insufficient to eliminate high numbers of E. coli O157:H7. The moisture content of feed influences the effectiveness of the heat treatment, with greater reductions at higher moisture content.

Pathogens surviving during pelleting may explain the increased occurrence of high Salmonella seroprevalence in swine fed pelleted feed diets compared to non-pelleted diets. Alternatively, post-heat recontamination in the mill or during transport could negate the effectiveness of thermal treatments.

Chemical treatments of feed to reduce pathogen contamination include acids (formic, hydrochloric, nitric, phosphoric, propionic and sulfuric), isopropyl alcohol, formate and propionate salts and trisodium phosphate. However, to minimize corrosion of feed equipment and deleterious effects to animal growth or health, buffered organic acids rather than unbuffered acids have been favored for use in animal feed.

In addition to feed formulation changes, many different feed additives may affect enteric pathogen colonisation, including antibiotics, sodium chlorate, nitropropanol compounds, organic acids, prebiotics, probiotics and bacteriophages. For use of antibiotics, short-term application may be prudent to reduce the potential development of antibiotic resistance in microorganisms. However, its similarity to antibiotics used to treat humans has made its use controversial.²⁰

The USDA and FDA allow the use of chlorine in the water up to 50 parts per million (ppm), to destroy some of these organisms. Upper range chlorine levels transfer to the air and can irritate factory workers, so lower levels for example 20 ppm, are typically employed. This compromises anti-microbial effectiveness, as does organic matter and debris that accumulate in water and consume available chlorine. Indeed, even the upper allowable chlorine levels cannot eliminate or significantly reduce pathogenic organisms. In addition, chlorine in process waters has a tendency to react with a variety of organic materials, both from water and from poultry, to form a series of chloro-organic molecules for example trihalomethanes and chloramines. These substances have been implicated as mutagens and carcinogens.

Chicken carcasses are frequently contaminated with Campylobacter. Red meat, particularly beef, may be contaminated with E. coli 0157, which is a serious pathogen for humans. There is a need for improved carcass washing procedures at poultry processing plants and potentiated glycerol liquid is very valuable here. In the past red meat has been washed with 2% lactic acid which has an anti-bacterial effect, but potentiated glycerol offers another solution.

Cereals such as wheat and maize are stored for lengthy periods and are always exposed to the risk of loss of quality due to the growth of moulds. Moulds cause two major problems. Firstly they destroy the structure and nutritional value of the cereal, fruit or vegetable and secondly moulds produce mycotoxins, which can remain in the contaminated foodstuffs for a long time. Many mycotoxins are stable and heat resistant molecules so it is difficult to remove them from contaminated feeds or foods.

Modern animal and human nutrition is continuously searching for new methods and products to combat the risk to food and feed quality posed by bacteria and moulds.

Potentiated glycerol solution provides a new multi-functional ingredient with valuable properties to control bacteria, moulds, endotoxins and mycotoxins for use in these and other applications.

Contamination of the environment in which animals are housed has been implicated as a source of pathogen contamination. Hence, general farm hygiene is important as farms with poorer hygienic practices can produce pathogen-infected herds and flocks.

One control measure is the proper use of disinfectant foot dips. Frequent changing of foot dips is recommended as such measures reduce Campylobacter infection rates of poultry by about 50%. Potentiated glycerol could also be of value here.

Selection of bedding and litter materials can also influence environmental pathogen contamination. For example, litter moisture is normally between 25% and 35% and limiting water activity to these levels creates a less favourable environment for the growth of Salmonella than more moist environments. In the case of cattle bedding, E. coli O157:H7 persist at higher cell numbers in used-sawdust than in used-sand bedding. Treatment of poultry litter with aluminum sulfate or sodium bisulfate significantly reduces Campylobacter colonization in ceca, but has no effect on Salmonella colonisation of poultry.

Similarly, terminal disinfection, either through fogging or misting of formaldehyde, decreases but does not eliminate Salmonella contamination in poultry houses. Hygienic conditions of holding and transportation facilities should not be ignored as even brief exposures (<3 h) to these environments when contaminated with salmonellae lead to infection of pigs with Salmonella.

There are differences in effectiveness among decontamination treatments, with immersion of poultry transport containers in hot water (60 or 70° C. for 30 seconds) reducing coliforms by 4.2 logs compared to a 1.6 log reduction by high-pressure spray treatments.²⁰

Fruit and vegetables intended for human consumption also frequently suffer contamination, infection and subsequent deterioration due to the growth of fungi, bacteria and viruses. Microbial contamination of fruits, vegetables, nuts and meats is of both public health and of economic interest. For example, fungal contamination of various fruits and nuts reduces their shelf life and can render them inedible. Fungal contamination also leads to the production of mycotoxins, which can be important in nuts. Vegetables may be contaminated with pathogenic strains of E. coli.

Fruits are washed in various products in an attempt to increase shelf life and kill harmful microorganisms. Bacterial diseases of apples include blister spot (Pseudomonas syringae), Crown gall (Agrobacterium tumefaciens), Fire blight (Erwinia amylovora) and hairy root (Agrobacterium rhizogenes), whereas examples of viral diseases are Apple mosaic, Apple chlorotic leafspot (ACLSV), Apple dwarf (Malus platycarpa), Apple stem pitting virus (ASPV), etc.

Pests and diseases in fruits and vegetables can have a negative economic impact on individual commercial producers and on the entire fruit and vegetable industry. Fungi are major causes of plant disease, accounting for perhaps 70% of all the major crop diseases. The fungi that cause major damage to stored fruits and vegetables are necrotrophic pathogens for example the common apple-rotting fungi, Penicillium expansum and Monilinia fructigena, the common ‘anthracnose’ fungus of bananas, Colletotrichum musae and the common ‘grey mould’ of strawberry and other soft fruits, Botrytis cinerea.

Monilinia fructicola is a species of fungus in the order Helotiales. A plant pathogen, it is the causal agent of brown rot of stone fruits. Penicillium expansum is a blue-colored mold responsible for the post-harvest decay of stored apples and produces the carcinogenic metabolite patulin. The primarily treatment is chemical, using fungicidal sprays to control the spread of the fungus.¹⁷ Grey mould is a very common spoilage disease of soft fruits such as strawberries, raspberries and grapes. It is seen as a powdery grey mass over the fruit surface, and it spreads rapidly, causing extensive rotting of the fruit. The fungus that causes this, Botrytis cinerea¹⁸, also is a major cause of damage to cut flowers.

Fungicides used on stone fruit for brown rot and/or powdery mildew, include for example triazoles, piperazines, pyridine carboxamides, anilinopyrimidine, hydroxyanilide, dicarboximide, benzimidazole, phthalimide and chloronitrile. Fungicides can be applied to grains when being stored, and some types are applied to protect mature fruits and vegetables once harvested. The over-use of fungicides in one class of compounds leads to resistance problems. As fungicides are removed from the marketplace and resistance to fungicides continues to develop in microbial populations, new approaches to control plant diseases are needed.¹⁷

Potentiated glycerol solution provides a new approach as this is effective in controlling microbial, for example fungal infections, works non-selectively and is therefore not limited by resistance issues common to existing fungicides.

The Applicant has found that potentiated glycerol is effective in fruit preservation. The in vitro testing of a non-viscous, sprayable potentiated glycerol solution against representative pathogenic fruit fungi (Monilinia laxa and Botrytis cinerea) is set out in Example 3. Medicinal applications such as the treatment of human skin and nails for example the fungal infection known as athlete's foot, is another example.

Athlete's foot is a fungal infection of the skin that causes scaling, flaking, and itch of affected areas. It is caused by fungi in the genus Trichophyton and is typically transmitted in moist areas where people walk barefoot, such as showers, locker rooms, gyms and poolside areas. People who suffer from athlete's foot experience itchiness in the affected areas, often between the toes. There is redness and tenderness in those areas as well as cracking of the skin. Athlete's foot may also cause the skin to break, resulting in blisters. In cases that are not treated early, people with athlete's foot may also develop yellowed and thick toenails because of the spread of fungi. Although the condition typically affects the feet, it can spread to other areas of the body.

Conventional treatment typically involves daily or twice daily application of a topical medication in conjunction with hygiene measures. The fungal infection may be treated with topical anti-fungal agents, which can take the form of a spray, powder, cream, or gel. The most common ingredients in over-the-counter products are miconazole nitrate and tolnaftate. Terbinafine is another common over-the-counter drug.

Potentiated glycerol provides an alternative to existing treatments for athlete's foot as it works non-specifically against microbes and potential drug resistance issues therefore do not apply.

Due to its demonstrated potent anti-fungal properties, potentiated glycerol compositions can also be very suitable for the disinfection treatment of animals, for example in the treatment of animal hides and teat cleaning. Potentiated glycerol compositions can also be used as a general household and industrial cleaning, sanitisation, disinfection agent. Potentiated glycerol compositions are effective in sterilising, sanitising, disinfecting, preserving, decontaminating, detoxifying or combinations thereof on a wide range of substrates by exposing the substrate to the composition through for example mixing, dipping, spraying, misting, fogging, painting or the like.

Substrates and application areas for treatment with potentiated glycerol formulations include, but are not limited to, the following categories:
1. Food products, for example fruit, vegetables, grains, seeds, nuts, herbs, spices, salad ingredients, carcasses, meat and meat-derived products, fish and fish-derived products and eggs.
2. Animals such as livestock for example as hide washing, teat treatment and disinfection.
3. Animal feed or animal feed products, which include but are not limited to any compound, preparation, mixture, or composition suitable for, or intended for intake by an animal for example milled or unmilled dried or wet grains such as corn, wheat, barley, rye, rice, sorghum and millet including grain based products comprising fractions of wet or dry milled grain for example gluten, protein, starch, and/or oil fractions and spent distiller's grains produced as by-products from fermentation processes, cereals, compound feed, soy meal, rapeseed meal, straw, hay and the like.
4. Animal bedding materials, for example straw, wood chips, hay and the like.
5. Medicinal applications for example treatment of fungal infections of the skin and nails such as the fungal infection known as athlete's foot.
6. General household and industrial cleaning, sanitisation and disinfection applications including the inactivation and/or removal of microbial biofilms.
7. Plants, vegetation, trees and flowers including cut flowers.

The term “animal” includes all animals, including human beings. Examples of animals are pets, cattle, (including but not limited to cows and calves), mono-gastric animals, for example pigs or swine (including, but not limited to, piglets, growing pigs, and sows), poultry such as turkeys and chicken (including but not limited to broiler chicks, layers) and fish.

Another important application area for potentiated glycerol is in the prevention of mycotoxin formation through fungal kill, prevention of new mycotoxin formation through fungal growth inhibition as well as the destruction of existing mycotoxins.

A further application area for potentiated glycerol is in the destruction of endotoxins. Endotoxins are lipopolysaccharides, a major constituent of the outer cell wall of Gram-negative bacteria. Large amounts of endotoxins can be mobilised if Gram-negative bacteria are killed or destroyed by detergents. Endotoxins are in large part responsible for the dramatic clinical manifestations of infections with pathogenic Gram-negative bacteria, such as Neisseria meningitidis, the pathogens that causes meningococcal disease, including meningococcemia, Waterhouse-Friderichsen syndrome, and meningitis.

The Applicant has found that potentiated glycerol is effective in the destruction of an endotoxin (Example 7).

The presence of mycotoxins in feeds and feed ingredient is a constant threat to animal and human health. Mycotoxins are toxic fungal metabolites that can be produced during fungal infection of grain crops. This fungal infection can occur during growth and prior to harvest, or during storage of the grains post harvest. Different fungal infections can produce a variety of mycotoxins under different environmental conditions. Corn and distiller's grains produced from corn for example are important and commonly used components of poultry feed and represent a likely source of potential contamination. The major causes are the fungal pathogens that cause ear rot diseases in corn i.e. Gibberella, Aspergillus, Fusarium and Penicillin.¹⁹

Mycotoxins are natural products of filamentous fungi that cause acute toxic or chronic carcinogenic, teratogenic or oestrogenic responses in higher vertebrates and other animals. Exposure is usually by consumption of contaminated feeds but may also be by contact or inhalation.

The mycotoxins that pose the greatest potential risk to human and animal health as food and feed contaminants are aflatoxins, ochratoxin A, zearalenone, trichothecenes, and fumonisins. Both acute and chronic mycotoxicoses reduce animal production and increase costs. When farm animals are exposed either to high levels of mycotoxins or to lower levels over a longer period of time, there is also a risk that significant amounts of the mycotoxins will be carried over into animal products such as milk, eggs and meat. Control of mycotoxins in animal feed is thus of great importance.

Mycotoxins are, in general, chemically and thermally stable compounds. Once a mycotoxin-contaminated ingredient is screened and enters the milling process, mycotoxins are likely to be retained in the finished product and further removal of mycotoxins is difficult.

In practice, decontamination or detoxification of mycotoxins can be achieved by removal or elimination of the contaminated commodities or by the inactivation of toxins present in the commodities through various physical, chemical, and biological means depending on the commodities.

Ideally, each treatment of food/feed processing and/or decontamination, in addition to assuring an adequate wholesome food/feed supply, should fulfil the following criteria:
(1) inactivate, destroy, or remove the toxins,
(2) destroy fungal spores and mycelia, so that new toxins are not formed,
(3) not produce or leave toxic residues in the food/feed,
(4) retain nutritive value and food/feed acceptability of the product,
(5) not significantly alter the technological properties of the product, and
(6) be economically feasible and thus the cost should be considerably less than the value of the decontaminated crop

Although a variety of decontamination methods have been tested and several show potential for commercial application, large-scale, practical, and costs-effective methods for complete mycotoxin decontamination are currently not available. Moreover, no single decontamination method that is equally effective against the variety of mycotoxins that can occur has been developed.

The effect of alkaline agents other than ammonia, such as sodium, potassium, or calcium hydroxides in aqueous medium on the destruction of mycotoxins is slightly less than ammonia treatment. However, the efficacy of salts such as calcium oxide and calcium hydroxide, which are poorly soluble in water, could be greatly enhanced through the combination with glycerol in potentiated glycerol formulations compared to solutions in water, therefore requiring much lower doses to achieve the same effect.

Although there are many publications on chemical transformation of mycotoxins, their applications in detoxification have been limited. This may be due to lack of information about mechanisms of transformation, toxicity of transformation products, and effects of the transformation reactions on nutritional values of the food and feed. Structures, stability and toxicity of transformation products and potential side-effects of the transformations should be investigated. Without this knowledge, no real advantage can be taken of these transformation reactions in the human and animal food chains.

Other treatment methods include physical treatments for example removal of damaged kernels, fluorescence sorting, sieving, flotation, rinsing, wet milling, roasting, heat processing, gamma radiation and sunlight. These methods have limited practical applications as they are expensive, highly variable in success rate and effect on the type of mycotoxin and often result in substantial feed losses.¹²

Mycotoxins are produced by fungi found in both animal feedstuffs and human foods. These naturally-occurring poisons can cause kidney and liver damage, cancer, suppress the immune systems, induce malnutrition and interfere with the reproductive system among other acute and chronic disease states.

Contamination of feed by mycotoxins results in significant economic losses for grain producers and, when consumed, can limit growth and create health problems for animals. Hundreds of mycotoxin-producing moulds exist, all with different frequencies and patterns of occurrence. However, in general, the mycotoxin problem is seen to be a growing one.

Consequently, the livestock and poultry industries experience great losses due to the presence of mycotoxin contamination in feeds. In this light, the recognition and prevention of mycotoxicoses is extremely important and must be dealt with at pre- as well as post-harvest level to reduce consumption by animals.

Aflatoxins (found mostly in corn, peanuts, soy, cottonseed and nuts) are the best-known mycotoxins and cause liver damage and liver cancer along with immune suppression and disruption of absorption and metabolism of essential nutrients. Aflatoxins are produced by Aspergillus flavus and Aspergillus parasiticu, which grows best at 14-30% moisture and around 25 degrees Celsius. Since only 20 ppb total aflatoxins are allowed in US human food and dairy feeds and US milk must be less than 0.5 ppb, aflatoxin is monitored by most feed companies. In the EU Aflatoxin B1 is regulated by Directive 2002/32/EC. Contaminated feeds exceeding the maximum levels may not be marketed and/or used for animal feeding or be mixed for dilution purposes.¹²

Aflatoxins (AF) have a high impact in both human and animal health, causing significant economic losses in the poultry industry, especially by diminution of avian growth, feed efficiency, and product quality. Aflatoxins affect the whole organism, particularly the liver and kidney.²¹

Zearalenone, found in grains (primarily corn), is one of the most powerful environmental estrogens known and, in contrast to aflatoxin, is not as frequently monitored at any step of the food chain, except in the case of some hog feeds. Zearalenone (and related compounds and isomers) is produced by Fusarium moulds that grow best at 20-25° C. at an optimum moisture level of 45%, but can grow at moisture levels above 25%. These toxins are powerful environmental estrogens and reproductive toxins. These reproductive effects include malformation of the genitals, infertility, feminization of males and early puberty and breast development in a variety of mammals, including humans.

DON (deoxynivalenol, vomitoxin) is one of the many trichothecene mycotoxins produced by Fusarium species of mould and causes reduced feed intake and a range of adverse symptoms in infected corn as well.^{11,22}

The most common mould species that produces vomitoxin is Fusarium graminearum (Gibberella zeae) and this mold infestation induces a plant disease called Gibberella Ear Rot or Fusarium Head Blight. This mould can attack corn as well as small grains such as wheat and barley and has been shown for decades to cause severe economic losses to crop and animal producers in North America. In USA states such as Ohio and Indiana DON levels in corn as high as 30 ppm have been reported recently.

Mycotoxins interact among themselves to increase toxicity in poultry. Many of these interactions are additive but can be synergistic as well. These interactions can occur at lower concentrations too. More than one hundred Fusarium mycotoxins have been chemically characterized, which makes complete analysis of feedstuffs for Fusarium mycotoxins impractical, if not impossible.

Other harmful mycotoxins include but are not limited to citrinin, ochratoxin A and fumonisins. These cause various effects including severe damage to the kidney and brain and are known to give dairy producers false positive field tests for antibiotics in the milk. The dramatically increased awareness of the hazards of mycotoxins has led to the development and marketing of a wide variety of rapid detection methods, although the quality of these varies.

A recurring vision for those working in feed protection is an additive that can bind to mycotoxins and prevent their absorption by the animals fed contaminated feed. Unfortunately, there have been few successes in this area, and they tend to be of rather narrow application. For example hydrated sodium calcium alumino-silicates (HSCAS) can selectively bind aflatoxin B1 without depleting micro-nutrients and are widely used in animal feeds. A few other clays of similar chemistry and mineral lattice architecture have some efficacy as well.

Once mycotoxins are formed in feed, there is not much that can currently be done to effectively get rid of them. In theory, a combination of heat with ammonia can irreversibly detoxify aflatoxins but this may affect feed texture and palatability. Ammonia can help prevent mould growth to some extent, but not as well as propionic acid.

Propionic acid can help inhibit mould growth and thereby prevent the production of mycotoxins. Therefore, if high moisture corn or other fermented material has to be transported from one place to another for subsequent storage or remote and delayed feeding, adding this silage preservative can prevent the mould growth that often occurs under those circumstances.

Propionic acid is also the rare exception to the general lack of post-synthesis destruction of mycotoxins as it can destroy citrinin at propionate concentrations used for general silage preservation.¹¹ Diluting an adulterated feed with clean feed to bring the total level below regulatory or toxic thresholds is tempting and often practiced. But the FDA frowns on this practice except in dire regional emergencies and it is banned in the EU.^{11,12}

The complete elimination of mycotoxin-contaminated commodities is not available at this time. Large-scale, practical, cost-effective methods for complete decontamination are not available. Also, no single decontamination method that is effective against the variety of occurring mycotoxins has been developed yet, thus prevention (of mycotoxin formation through killing or inhibition of mycotoxin-producing fungi) is currently better than cure.¹²

It was reported at the British Society of Animal Science Annual Conference, Queens's University, Belfast in April 2010 that, following wet harvests, using straw, particularly wheat straw, as a bedding material for pigs can result in the intake of dangerously high levels of mycotoxins.²³

UK cereal straw, in particular wheat straw, can contain high levels of Fusarium mycotoxins and, although there is limited data on the rate of consumption of bedding straw, one study calculated that weaned pigs consumed about 1.6 kg per day. Based on the levels of Fusarium mycotoxins found in straw, this could be a significant proportion of the mycotoxin load consumed by pigs and contribute to sub-clinical and clinical mycotoxicosis.

It has been reported that several cases of Zearalenone (ZEA) mycotoxicosis occurred within the pig industry since the 2008 harvest. ZON mimics oestrogen resulting in hypero-estrogenism. Symptoms reported include swollen vulva in newborn piglets, reduced litter numbers and increased numbers of weak and/or deformed piglets at birth.

It was shown that mycotoxins within bedding straw could contribute to mycotoxicosis. Straw-based production systems are common in the UK compared to other countries. The effects of mycotoxins in cereal feed on livestock performance are relatively well documented with pigs being particularly sensitive to mycotoxicosis. A previous study in 2006 identified straw as a potential source of Fusarium mycotoxins for livestock on straw bedding.

Potentiated glycerol is a new mycotoxin prevention and existing mycotoxin destruction option for treatment of animal bedding materials such as straw. Potentiated glycerol liquid has been shown at a leading mycotoxin laboratory in Italy (ISPA-CNR, National Research Council of Italy, Institute of Sciences of Food Production) to have a potent in vitro destroying effect against a range of mycotoxins of commercial interest. The in vitro testing of a dilute potentiated glycerol composition against a selection of important mycotoxins of commercial interest is set out in Example 4.

The study was aimed at assessing the efficacy of a liquid potentiated glycerol composition to reduce the mycotoxin concentration of a multi-toxin aqueous solution. The study also evaluated the effect of the retention time of the process on the rate and extent of mycotoxin reduction.

A potentiated calcium-glycerol powder, which was previously prepared from calcium oxide and wet, biodiesel by-product glycerol according to the method described in PCT/IB2009/052931 as a source of solubilised calcium hydroxide and glycerol when mixed with water, was tested in aqueous medium against the following mycotoxins: aflatoxin B1 (AFB1), ochratoxin A (OTA), zearalenone (ZEA), fumonisin B1 (FB1), deoxynivalenol (DON), and HT-2/T-2 toxins (HT-2/T-2).

Extraction (mixing followed by filtration of the suspension) of 8 gram of this potentiated glycerol powder with 100 ml water at room temperature in a separate experiment gave, a clear, transparent aqueous solution of calcium hydroxide and glycerol with a glycerol content of 10% (w/w) and solubilised calcium hydroxide content of 0.39% (w/w) (calcium, 0.21% w/w; hydroxide, 0.18% w/w). This (0.39% w/w) exceeded the maximum amount of solubilised calcium hydroxide (0.17%) in a saturated calcium hydroxide solution at room temperature due to the enhanced solubilisation effect which is facilitated by the presence of the extracted glycerol in solution.

To assess the simultaneous detoxification of toxins, the test material was added to an aqueous solution (pH 7) containing the mixture of mycotoxins at 2 μg/mL concentration, and at a fixed temperature (37° C.) and reaction time. The effect of three reaction times (2 hours, 1 day and 1 week) on toxin reduction was assessed.

A rapid reduction of mycotoxins was observed. The 1 day and 1 week treatment with the dilute potentiated glycerol composition reduced all mycotoxin levels below the quantification limits of the liquid chromatography (LC) method used with the exception of aflatoxin B1, which was reduced by 84% after a contact time of 1 day (Table 2).

As expected, mycotoxin reduction in aqueous solution was higher after longer contact times. The 1 day decontamination treatment completely reduced OTA, DON, FB1, T2 and HT-2 toxins. Prolonged incubation time (1 week) gave complete reduction of all mycotoxin contents.

TABLE 2
Reduction in mycotoxin content of a multi-toxin aqueous
solution (2 μg/mL) by treatment with potentiated glycerol
for 2 hours, 1 day and 1 week, respectively.

| | | MYCOTOXIN RECOVERIES (%) | | | | | |
|---|---|---|---|---|---|---|---|
| PROD- | | Mean ± SD (n = 3) | | | | | |
| UCT | Time | AFB1 | ZEA | OTA | DON | FB1 | HT-2/T-2 |
| Poten- | 2 h | 64 ± 1 | 38 ± 1 | 0 ± 0 | 43 ± 0 | 2 ± 0 | 0 ± 0 |
| tiated | 1 day | 16 ± 0 | 0 ± 0 | 0 ± 0 | 0 ± 0 | 0 ± 0 | 0 ± 0 |
| Glyc- | 1 week | 0 ± 0 | 0 ± 0 | 0 ± 0 | 0 ± 0 | 0 ± 0 | 0 ± 0 |
| erol | | | | | | | |

As shown in Table 2, the solid potentiated glycerol test material in aqueous medium in the present study at was effective in simultaneously reducing the levels of all mycotoxins present in the aqueous solution.

Four toxins, out of 7 mycotoxins assayed, i.e. FB1, OTA, T-2 and HT-2 were especially unstable under alkaline conditions obtained by treatment with potentiated glycerol. Reduction of some toxins was a rapid process, as OTA, T-2 and HT-2 were undetectable in supernatant samples after the first assessed contact time of only 2 hours. Total destruction of DON and ZEA was achieved after 1 day treatment with 84% reduction achieved for AFB1. Prolonged incubation time (1 week) gave complete reduction in the levels of all mycotoxins.

The degradation products of the observed mycotoxin destruction were of unknown structure. With the exception of FB1 (which was hydrolyzed to HFB1), no major increasing chromatographic peaks coinciding with the decline of mycotoxins were observed.

This the first time that potentiated glycerol has been shown to reduce mycotoxin content in aqueous solution and shows that potentiated glycerol compositions has a useful application as a functional feed ingredient in decontaminating multi-mycotoxin contaminated grains and feeds.

As the test material in the preliminary study was dilute and contained well below optimal hydroxyl ion and glycerol levels, the effect when using higher hydroxyl ion concentrations in more concentrated potentiated glycerol compositions is expected to be much higher leading to increased mycotoxin destruction efficacies over shorted contact times and hence the need for much reduced doses on substrates such as compound feed where the target dose ideally is below 1% by weight of treatment agent to feed substrate.

The Applicant is of the view that potentiated Glycerol Compositions such as the relatively dilute test material assessed as well as more concentrated formulations thereof, will be effective in proportionally smaller doses as a function of the solubilised hydroxyl ion concentrations therein to achieve similar mycotoxin destruction efficacies and have a useful application as a functional feed ingredient in decontaminating multi-mycotoxin contaminated grains and feeds.

The relative mycotoxin detoxifying effect of a Potentiated Glycerol solution with solubilised calcium hydroxide content of 2.31% (w/w) and glycerol content of 78.4% (w/w)) undiluted and 1:1 diluted in water versus a (glycerol-free) 25% (w/w) calcium hydroxide reference suspension in water was subsequently tested against the mycotoxins, zearalenone and HT-2 toxin, respectively in corn as animal feed matrix (Example 5).

The moisture content of the corn was adjusted to 14% (w/w). The treatment agents were applied at 5% onto the corn, except the 1:1 diluted agents, which were applied at 10% (resulting in 5% active material). The final moisture content of all samples was between 13 and 17%.

After 24 hours incubations, the mycotoxins were extracted from the feed and the extracts were analysed by HPLC.

The results depicted in Table 3 are presented as mycotoxin percentage decrease.

TABLE 3
Decrease in mycotoxin content (%) on a feed matrix after treatment
with a potentiated glycerol solution versus calcium hydroxide
control, respectively, for 24 hours

| | | ZEA | HT-2 |
|---|---|---|---|
| | Amount (%) of | content | content |
| | calcium hydroxide | decrease | decrease |
| | added in treatment | (%) | (%) |
| Potentiated Glycerol | 0.05 × 2.31 = | 58 | 58 |
| Solution ACV294a | 0.1155% | | |
| (calcium hydroxide, | | | |
| 2.31%; glycerol, | | | |
| 78.4%) | | | |
| Potentiated Glycerol | 0.1 × 1.155 = | 47 | 62 |
| Solution ACV294a | 0.1155% | | |
| diluted in water | | | |
| (calcium hydroxide, | | | |
| 1.155%; glycerol, | | | |
| 37.25%) | | | |
| Calcium hydroxide | 0.05 × 25 = | 42 | 50 |
| suspension in water | 1.25% | | |
| (calcium hydroxide, | | | |
| 25%; glycerol, 0%) | | | |

As shown in Table 3, the potentiated glycerol solutions applied at an effective dose of 0.1155% (w/w) calcium hydroxide was more effective in reducing the levels of both zearalenone and HT-2 toxin in the corn feed matrix compared to the glycerol-free calcium hydroxide control at a 10.8-fold higher dose of 1.25% (w/w) calcium hydroxide as tested.

In a separate trial the anti-microbial activity of a potentiated glycerol solution was assessed against biofilms of Staphylococcus aureus, Pseudomonas aeruginosa and Candida albicans (Example 6).

The aim of this experiment was to first determine the minimum inhibitory concentrations (MICs) of a clear Potentiated Glycerol solution with a glycerol concentration of 75.3% (w/w) and dissolved calcium hydroxide concentration of 2.04% (w/w) against planktonic cells of Staphylococcus aureus, Pseudomonas aeruginosa and Candida albicans, respectively, in comparison to a non-potentiated (glycerol-free), aqueous solution of calcium hydroxide in water as control with a dissolved calcium hydroxide concentration of 0.078% (w/w). The MIC results are depicted in Table 4.

TABLE 4
Minimum inhibitory concentrations (MICS) of a potentiated glycerol
solution and a calcium hydroxide solution control for Staphylococcus
aureus, Pseudomonas aeruginosa and Candida albicans

| | Candida | Staphylococcus | Pseudomonas |
|---|---|---|---|
| | albicans | aureus | aeruginosa |
| Potentiated Glycerol | 12.5% | 3.1% | 6.25% |
| Solution ACV313b | | | |
| (calcium hydroxide, | | | |
| 2.04%; glycerol, 75.3%) | | | |
| Saturated, aqueous | 25% | >50% | >50% |
| Calcium Hydroxide | | | |
| solution ACV316 | | | |
| (calcium hydroxide, | | | |
| 0.078%; glycerol, 0%) | | | |

From the MIC results shown in Table 4 it is clear that the potentiated glycerol solution with solubilised calcium hydroxide content of 2.04% (w/w) exhibited a significantly stronger response against the planktonic microbial cells compared to the glycerol-free (non-potentiated), calcium hydroxide solution control with calcium hydroxide content of 0.078%. This is ascribed to the enhanced solubilisation effect of calcium hydroxide in the aqueous medium which is facilitated by glycerol. The maximum solubility of calcium hydroxide in (glycerol-free) water is about 0.17% (w/w) i.e. about 12 times less than the solubilised calcium hydroxide content of (non-optimised) potentiated glycerol solution as tested.

The MIC determination was followed by testing of the most potent antimicrobial solution (potentiated glycerol) at the determined minimum inhibitory concentrations in biofilm experiments wherein the activity of the potentiated glycerol solution against glycerol as reference was determined against biofilms of the microbial strains.

Biofilms of Staphylococcus aureus, Pseudomonas aeruginosa and Candida albicans were produced over 24 hours in microtitre plates. Aliquots of 100 μl of potentiated glycerol solution and glycerol as reference, respectively, were added to the wells, and incubated for 5 minutes. Resazurin viability staining was applied and fluorescence of the biofilms measured.

The results of this experiment are summarised in Table 5. The data are fluorescence per well (average±S.D.) obtained after resazurin-based viability staining. A lower signal means less surviving cells.

TABLE 5
Activity of a Potentiated Glycerol solution and Glycerol as reference
against microbial bioflims

| | Treatment | | |
|---|---|---|---|
| Micro- | | Potentiated | |
| organism | Control (none) | Glycerol (w/v) | Glycerol (w/v) |
| S. aureus | 160,000^{a}* ± 40,000 | 60,000^{b} ± 60,000 | 180,500^{a} ± 30,000 |
| | | (3.1%) | (10.0%) |
| P. aeruginosa | 25,000^{a} ± 8,500 | 0^{b} | 29,000^{a} ± 30,000 |
| | | (6.25%) | (10.0%) |
| C. albicans | 130,000^{a} ± 12,000 | 30,000^{b} ± 7,500 | 150,000^{a} ± 17,800 |
| | | (12.5%) | (10.0%) |

*Means with different superscripts in the same row are different P < 0.00001

A significant effect of the potentiated glycerol solution at the indicated minimum inhibitory concentrations against the biofilms of the selected micro-organisms was observed. Glycerol on its own actually supported the growth of the micro-organisms.

Due to its demonstrated potent anti-microbial and mycotoxin-destructing functions, potentiated glycerol is a very versatile, multi-functional agent which has numerous application possibilities.

In summary, potentiated glycerol are solid and liquid anti-microbial and toxin-destructing compositions containing glycerol and a hydroxyl ion providing, solubilised glycerol potentiating agent or glycerol potentiating agents, where the glycerol potentiating agent is calcium hydroxide, calcium oxide or mixtures thereof.

In the liquid potentiated glycerol compositions the glycerol content is from about 5% to 99.5% by weight of the composition, preferably from about 10% to 85% by weight of the composition and more preferably from about 20% to about 60% by weight of the composition.

The solution is optionally prepared as a concentrate with a glycerol content from about 60 to 99.5% by weight, and then diluted with a non-viscous co-solvent or mixture of co-solvents selected from water and alcohols to provide a solution which is easier to apply through for example spraying, misting or fogging and the like as required in certain applications.

The composition in its viscous or semi-viscous forms can also be applied without dilution, for example through mixing with or painting onto a substrate, to provide the maximum dose of hydroxyl ions onto the substrate so that the smallest dose amount can be applied to achieve the desired function and efficacy levels, for example sterilization and/or toxin destruction.

The potentiated glycerol liquid can optionally treated with activated carbon and filtered to provide a colourless product or product with reduced colour. This is applicable for example when using for example yellow-coloured, technical grade co-products glycerols from biodiesel production.

The potentiated glycerol is optionally filtered to provide a clear solution or concentrate free of undissolved particles, for example commercial grades of calcium oxide and calcium hydroxide powders as potentiating agents often contain small amounts of calcium carbonate which is almost insoluble in the medium, and therefore needs to be removed by filtration to provide clear solutions which are free from undissolved particles, sediments or precipitates which may cause problems such as blocking nozzles and the like when applied to a substrate through for example spraying or misting, and also leave unwanted residues on treated substrates surfaces.

The glycerol potentiating agent is an oxide and/or hydroxide salt of calcium, however, depending on the application the oxides and/or hydroxides of for example sodium, potassium, magnesium, iron or copper or mixtures thereof in any ratio may also be added as required or may already be present in the glycerol used in preparation of the potentiated glycerol composition. The wet, technical grade glycerol products produced commercially as co-products from biodiesel production for example do typically contain amounts of potassium and/or sodium salts which originate from the use of potassium hydroxide/potassium methylate and/or sodium hydroxide/sodium methylate as catalysts in these trans-esterification processes. The potentiating agent or agents are solubilised in the medium up to 100% of the solubility of the salt or combined maximum solubilities of the salt mixture in the selected glycerol medium.

The invention thus provides a composition in the form of a liquid, a solid or a semi-solid having anti-microbial and toxin-destroying properties, the composition comprising from about 5 to about 99.5% by weight of glycerol, from about nil to about 95% by weight of water and a source of hydroxide ions, the source of hydroxide ions being provided by calcium hydroxide calcium oxide or mixtures thereof in which the viscosity of the mixture is reduced by the optional addition of water to glycerol in order to improve mixing and optional filtration and in which the solubility of the calcium hydroxide or calcium oxide or mixture thereof in the composition or when the composition is combined with water is enhanced by the presence of the glycerol.

Preferably, the composition may be in the form of a liquid solution which comprises from about 20% to about 85% by weight of glycerol and from about 15 to about 80% by weight of the water.

The solution may comprise from about 0.17% to about 3.0% by weight as measured at room temperature (for example about 20° C.) of the one calcium salt or mixture of calcium salts and preferably from about 0.6 to about 2.6% by weight as measured at room temperature of the one calcium salt or mixtures of calcium salts. Calcium oxide is transformed to calcium hydroxide in water. The maximum solubility of calcium hydroxide in glycerol-free water at room temperature is about 0.17% by weight.

The solution may be in the form of a saturated solution of calcium hydroxide or calcium oxide or mixtures thereof. As the ratio of the glycerol and the water in the solution changes, the solubility of the calcium salt or calcium salts will also change. Accordingly, the concentration of the solubilised calcium salt or calcium salts in the saturated solution will also change and a person skilled in the art will readily be able to vary the ratio of glycerol and water to achieve a particular concentration.

Potentiated glycerol compositions comprising of suspensions, emulsions, pastes, slurries and the like of calcium hydroxide or calcium oxide or mixtures thereof with glycerol in water wherein the maximum solubility of the salt or salts in the aqueous medium is exceeded i.e. above the about 3% by weight threshold may also be used in applications where applicable in order to provide an additional reservoir of hydroxyl ions in applications where for example anti-microbial/preservation and/or anti-toxin efficacies are required through a slow/sustained release mechanism over extended periods of time onto substrates.

In the solid potentiated glycerol compositions the glycerol content may be from about 5% to 80% by weight of the composition, preferably from about 30% to 75% by weight of the composition and more preferably from about 40% to about 65% by weight of the composition. The solid potentiated glycerol compositions could be added to a substrate either in the solid form for example as a powder, granules, flakes or the like or as a mixture in water for example as a slurry, suspension, emulsion, paste or the like.

The solid calcium-glycerol material may be prepared either exothermically from calcium oxide and wet glycerol as described in the present applicant's earlier application PCT/IB2009/052931 (the contents of which are incorporated herein by reference) or non-exothermically for example by mixing calcium hydroxide with glycerol followed by drying step or steps for example heat drying and/or vacuum drying and/or air drying.

Here the same mechanism applies as in the cases of potentiated glycerol solutions i.e. the release of calcium hydroxide and glycerol in solution when the solid material is contacted with moisture on a substrate for example an animal feedstuff or on exposure to excess water which results in the enhanced solubilisation of the hydroxide in the aqueous medium which in its turn enhances the anti-microbial, anti-mycotoxin and anti-endotoxin efficacies of the solubilised hydroxyl ion in comparison to the restricted action of calcium hydroxide in a glycerol-free medium.

The invention extends to a method selected from destroying microorganisms including those present in biofilms, inhibiting the growth of microorganisms including those present in biofilms, preventing the growth of microorganisms including those present in biofilms, destruction and removal of microbial biofilms, destroying mycotoxin-producing moulds, inhibiting the growth of mycotoxin-producing moulds, preventing the growth of mycotoxin-producing moulds and at least partly destructing mycotoxins and endotoxins in or on a substrate, the method including the step of exposing the substrate to, or contacting the substrate with, a liquid or solid or semi-solid potentiated glycerol composition as hereinbefore described.

The microorganisms may be present in biofilms and the method results in the removal or destruction or partial removal or destruction of the biofilms.

Exposing the substrate to, or contacting the substrate with, the potentiated glycerol composition may be by a method selected from mixing, blending, dipping, spraying, misting, fogging, painting or applying the composition to the substrate.

The substrate may be a food product selected from fruit, vegetables, carcasses, meat, meat-derived products, fish, fish-derived products and eggs. It may instead be a non-human animal selected from domestic pets, cattle, mono-gastric animals, poultry and fish. It may instead be an animal feed or an animal feed product.

The substrate may instead be an animal bedding material. The animal bedding material may be selected from straw, wood chips and hay. The substrate may instead be a plant or a part of a plant. It may instead a part of a human body.

The invention extends to a household cleaning agent, an industrial cleaning agent, a sanitizing agent or a disinfecting agent comprising a composition as hereinbefore described.

The invention extends further to a method of preparing a solution having anti-microbial and mycotoxin-destroying properties, the method including the step of combining from about 5 to about 99.5% by weight of glycerol, from about nil to about 95% by weight of water and a source of hydroxide ions, the source of hydroxide ions being provided by calcium hydroxide or calcium oxide or mixtures thereof in which the viscosity of the mixture is reduced by the optional addition of water to glycerol in order to improve mixing and optional filtration and in which the solubility of the calcium hydroxide or calcium oxide or mixture thereof is enhanced by the presence of glycerol in the mixture.

The method may include preparing a solution as a viscous concentrate and diluting the concentrate by the addition of a non-viscous co-solvent selected from water, one or more alcohols and mixtures thereof.

The method may include a filtration step to remove any undissolved material. It may in addition or alternatively include an active carbon treatment step to provide a colourless solution or a solution with reduced colour.

According to another aspect of the invention, there is provided the use of a treatment composition for preventing, or reducing, the production of contaminants selected from microorganisms and microorganism-produced toxins by contacting the substrate with the composition, the composition including a water glycerol mixture and calcium hydroxide, the percentage by mass of glycerol in the water glycerol mixture being between 5% and 95%, at least some of the calcium hydroxide being dissolved in the water glycerol mixture and the concentration of the dissolved calcium hydroxide in the water glycerol mixture being at least 1.5 times higher than the maximum concentration of dissolved calcium hydroxide which can be obtained in water alone, thereby preventing or reducing the production of the contaminants, the extent of the prevention or reduction being at least 1.5 times more than the corresponding prevention or reduction produced by a treatment composition comprising water and calcium hydroxide only.

The percentage by mass of glycerol in the water glycerol mixture may be 20% or more and the concentration of the dissolved calcium hydroxide in the water glycerol mixture may be at least 3 times higher than the maximum concentration of dissolved calcium hydroxide which can be obtained in water alone. In an embodiment, the percentage by mass of glycerol in the water glycerol mixture may be 50% or more and the concentration of the dissolved calcium hydroxide in the water glycerol mixture may be at least 10 times higher than the maximum concentration of dissolved calcium hydroxide which can be obtained in water alone.

The extent of the prevention or reduction of microorganisms and microorganism-produced toxins by the treatment composition of the invention, compared with the corresponding prevention or reduction produced by a treatment composition comprising water and calcium hydroxide only, increases with the amount of glycerol present. For example, as the amount of glycerol is increased to 15%, 20%, 35%, 50%, 60% and 80%, the efficacy of the treatment composition of the invention compared with a treatment composition comprising water and solubilised calcium hydroxide only increases by factors of 2, 3, 5, 10, 13 and 15 respectively. In general, these increases typically follow the corresponding increases in the solubility of calcium hydroxide in the glycerol-water mixture but may vary on a case-by-case basis depending on the type of contaminant and treatment conditions.

The microorganisms may include moulds and the microorganism-produced toxins may be mycotoxins and/or endotoxins. The treatment composition may be produced from materials selected from solid glycerol-derived materials and semi-solid glycerol-derived materials, the solid materials being selected from powders, granules and flakes and the semi-solid materials being selected from pastes, slurries, emulsions and suspensions.

The glycerol-derived material may be produced by methods selected from reacting glycerol, water and a base selected from calcium oxide or a mixture of calcium oxide and calcium hydroxide in an exothermic reaction to produce the glycerol-derived material or by combining wet or dry glycerol and a base selected from calcium oxide, a mixture of calcium oxide and calcium hydroxide or calcium hydroxide and optionally drying the product to produce the glycerol-derived material.

The solid calcium-glycerol material may be the solid material prepared exothermically from calcium oxide and wet glycerol as described in the applicant's application PCT/IB2009/052931.

The substrate may be an animal feed or an animal feed product. Instead, it may be a food product selected from fruit, vegetables, grains, seeds, nuts, herbs, spices, salad ingredients, carcasses, meat, meat-derived products, fish, fish-derived products and eggs. Instead, it may be animal bedding material. Instead, it may be an animal or a human.

Contacting the substrate with the composition may be by a method selected from mixing, blending, dipping, spraying, misting, fogging or painting the substrate with the composition or applying the composition to the substrate with or without adding water to the substrate.

According to another aspect of the invention, there is provided a treatment composition for preventing, or reducing, the production of contaminants selected from microorganisms and microorganism-produced toxins, the composition including a water glycerol mixture and calcium hydroxide, the percentage by mass of glycerol in the water glycerol mixture being between 5% and 95%, at least some of the calcium hydroxide being dissolved in the water glycerol mixture and the concentration of the dissolved calcium hydroxide in the water glycerol mixture being at least 1.5 times higher than the maximum concentration of dissolved calcium hydroxide which can be obtained in water alone.

The percentage by mass of glycerol in the water glycerol mixture may be 20% or more and the concentration of the dissolved calcium hydroxide in the water glycerol mixture may be at least 3 times higher than the maximum concentration of dissolved calcium hydroxide which can be obtained in water alone. In an embodiment the percentage by mass of glycerol in the water glycerol mixture may be 50% or more and the concentration of the dissolved calcium hydroxide in the water glycerol mixture may be at least 10 times higher than the maximum concentration of calcium hydroxide which can be obtained in water alone.

The invention extends to an agent selected from household cleaning agents, industrial cleaning agents, sanitizing agents and disinfecting agents comprising a composition as described herein.

The invention is now described, by way of example, with reference to the following Examples, which describe the in vitro killing by potentiated glycerol compositions of representative pathogenic bacteria (Salmonella enterica abony, Campylobacter jejuni, Staphylococcus aureus, Pseudomonas aeruginosa and Candida albicans), pathogenic fruit fungi (Monilinia laxa and Botrytis cinerea) and the destruction of representative mycotoxins (aflatoxin B1 (AFB1), ochratoxin A (OTA), zearalenone (ZEA), fumonisin B1 (FB1), deoxynivalenol (DON), and HT-2/T-2 toxins (HT-2/T-2) and the Figures, in which

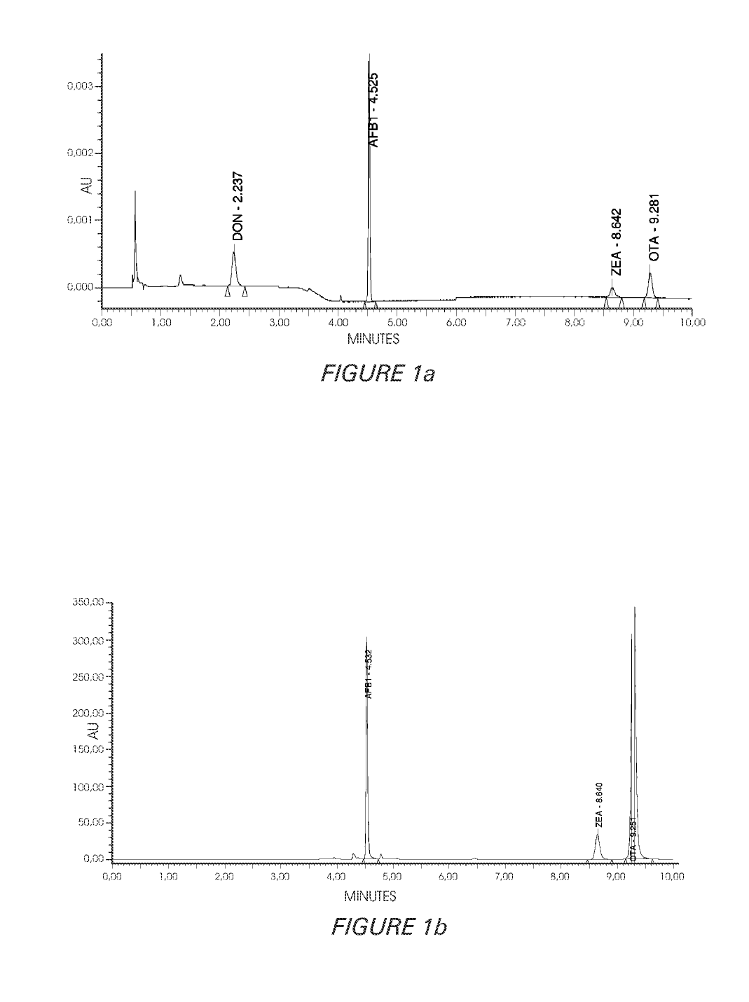

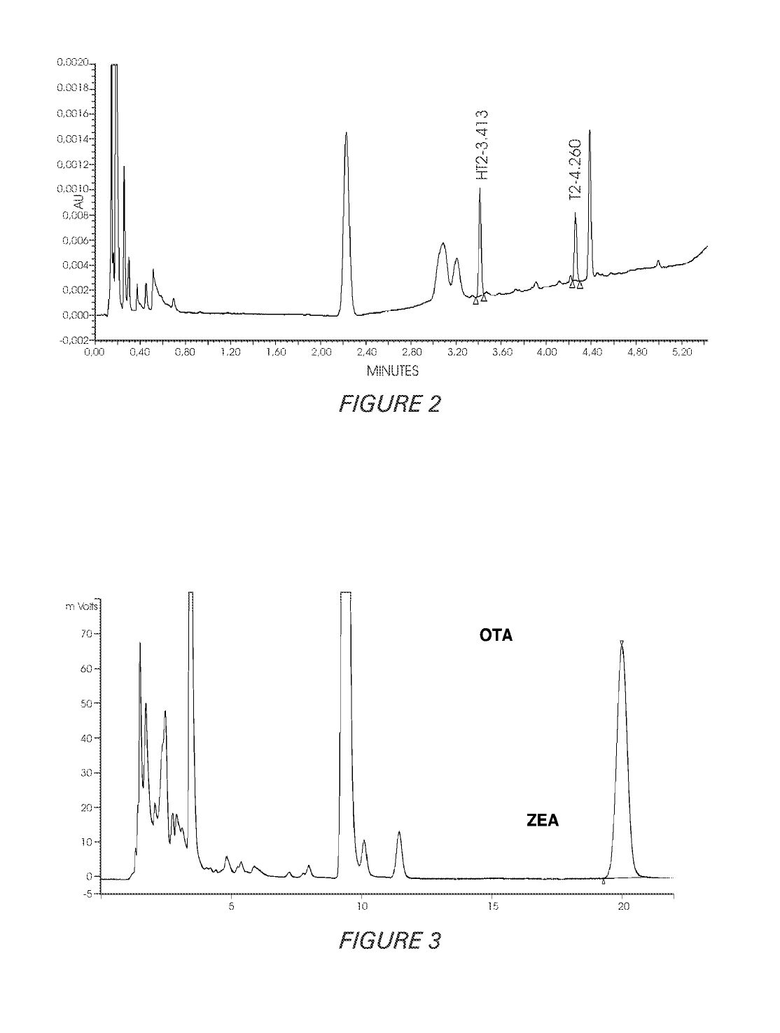

FIGS. 1a and 1b show a UPLC-PDA chromatogram (A) and UPLC-FLD chromatogram (B) obtained from a multi-toxin standard solution containing DON, AFB1, ZEA and OTA at 2 μg/ml,

FIG. 2 shows a UPLC-PDA chromatogram obtained from a multi-toxin standard solution containing T-2 and HT-2 toxins at 2 μg/ml,

FIG. 3 shows a HPLC-FLD chromatogram obtained from a multi-toxin standard solution containing FB1 at 2 μg/ml,

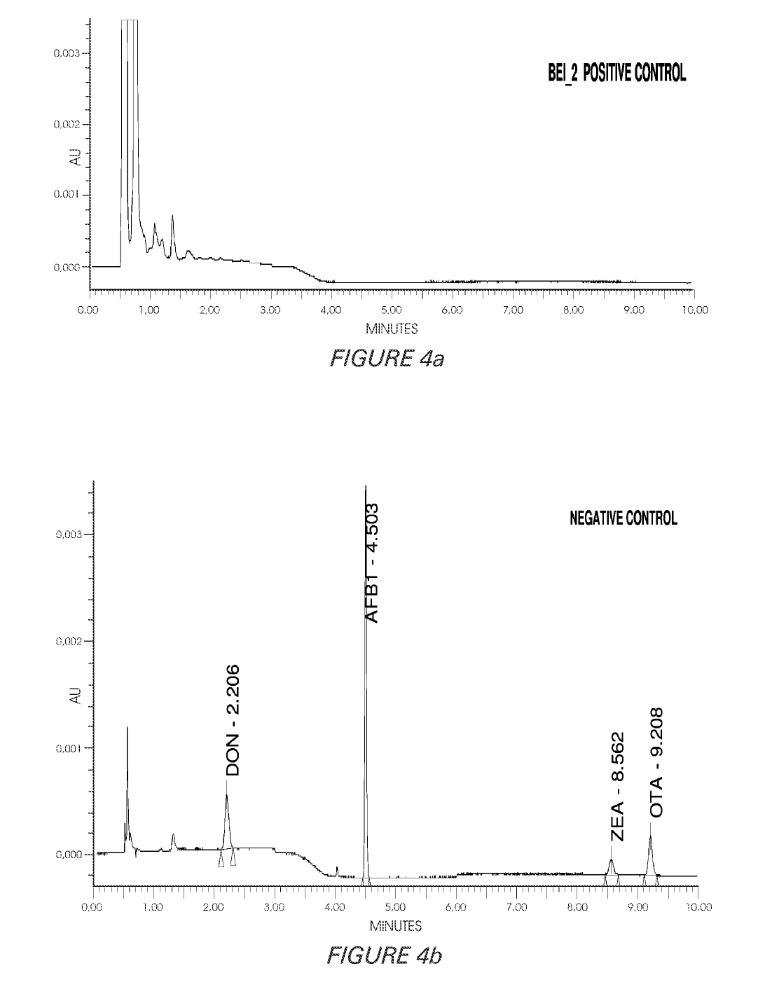

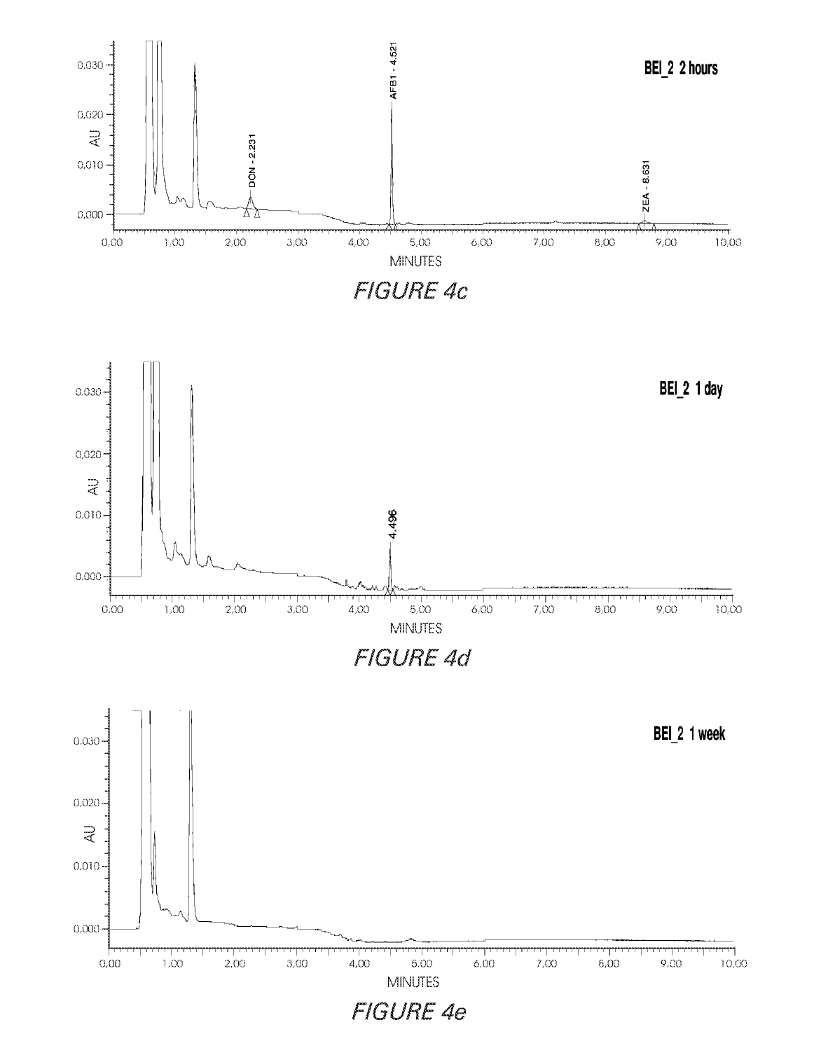

FIGS. 4a, 4b, 4c, 4d and 4e show UPLC-PDA chromatograms obtained by simultaneous analysis of DON, AFB1, ZEA and OTA in supernatant samples relevant to positive controls, negative controls and decontamination trials with Potentiated Glycerol test material; the efficacy of the Potentiated Glycerol test material (indicated as BEI_{—}2) and reducing mycotoxin content in aqueous solution (2 μg/ml) was assayed at different incubation times (2 hours, 1 day and 1 week),

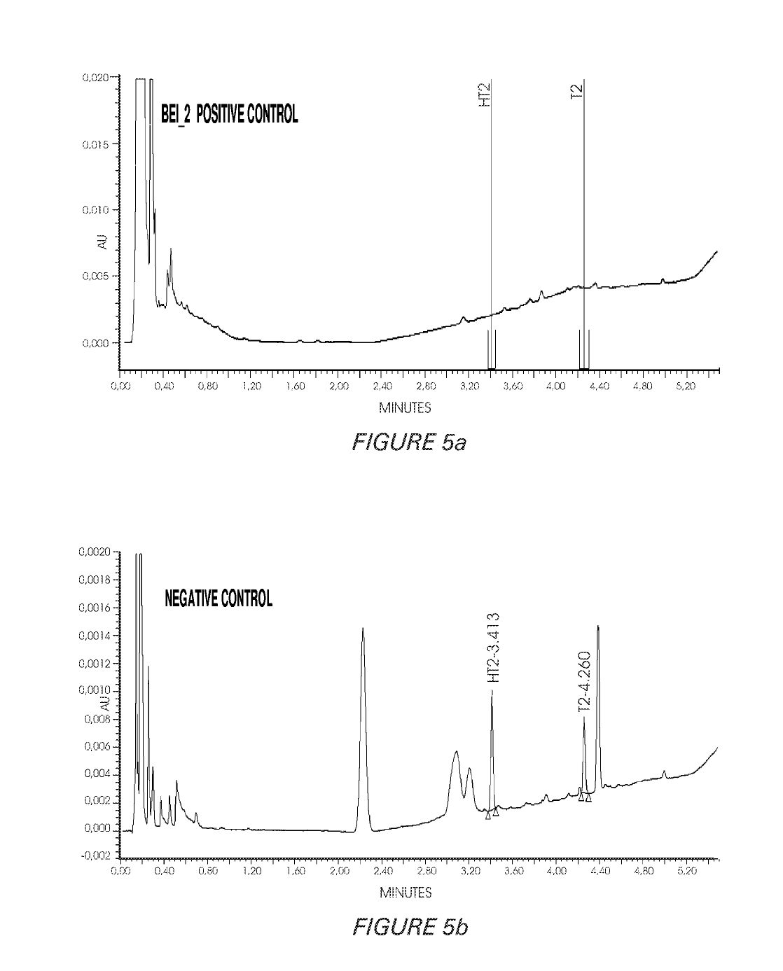

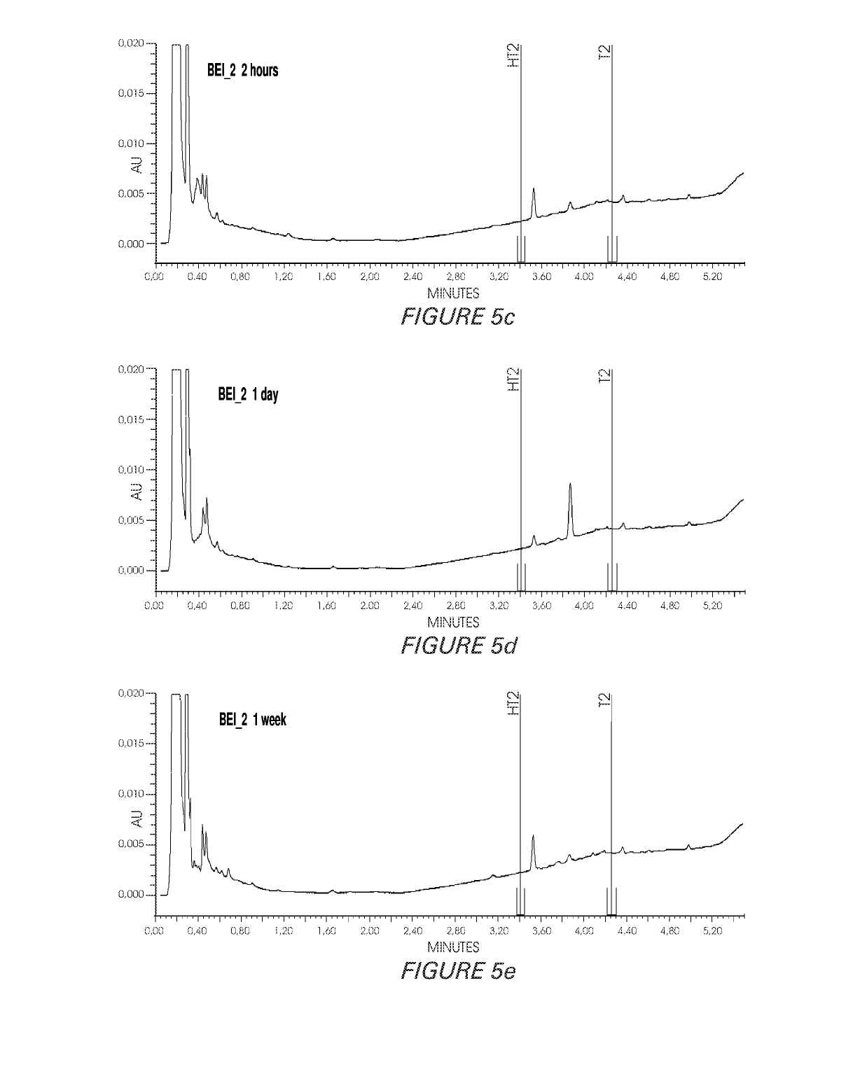

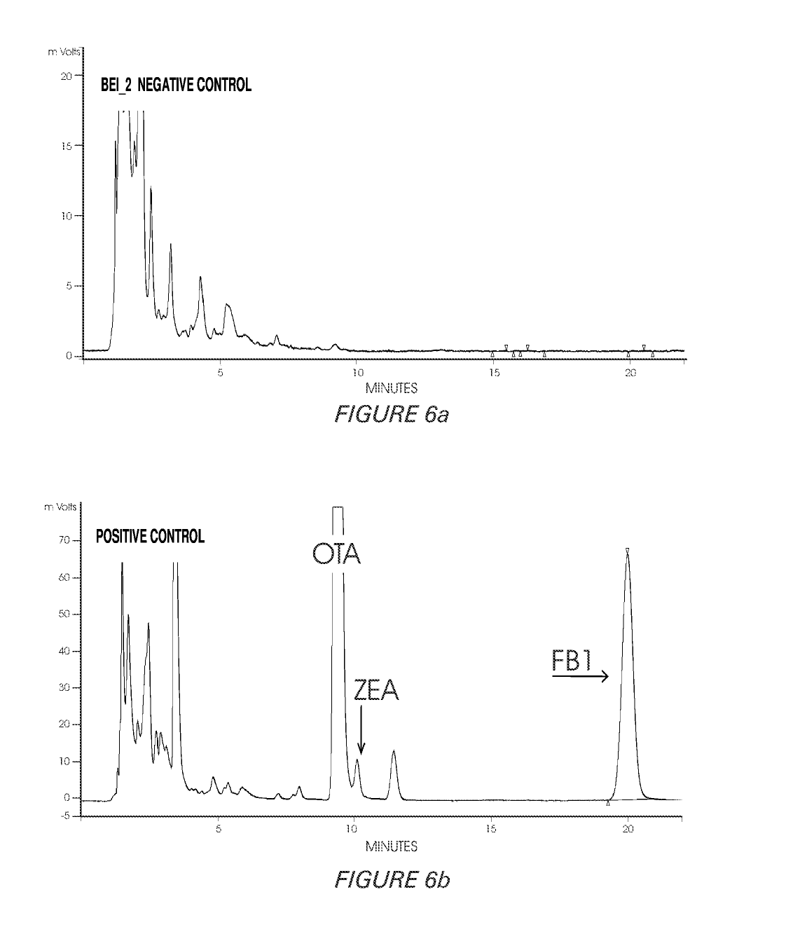

FIGS. 5a, 5b, 5c, 5d and 5e show UPLC-PDA chromatograms obtained by simultaneous analysis of HT-2 and T-2 in supernatant samples relevant to positive controls, negative controls and decontamination trials with Potentiated Glycerol test material; the efficacy of the Potentiated Glycerol test material (indicated as BEI_{—}2) and reducing mycotoxin content in aqueous solution (2 μg/ml) was assayed at different incubation times (2 hours, 1 day and 1 week),

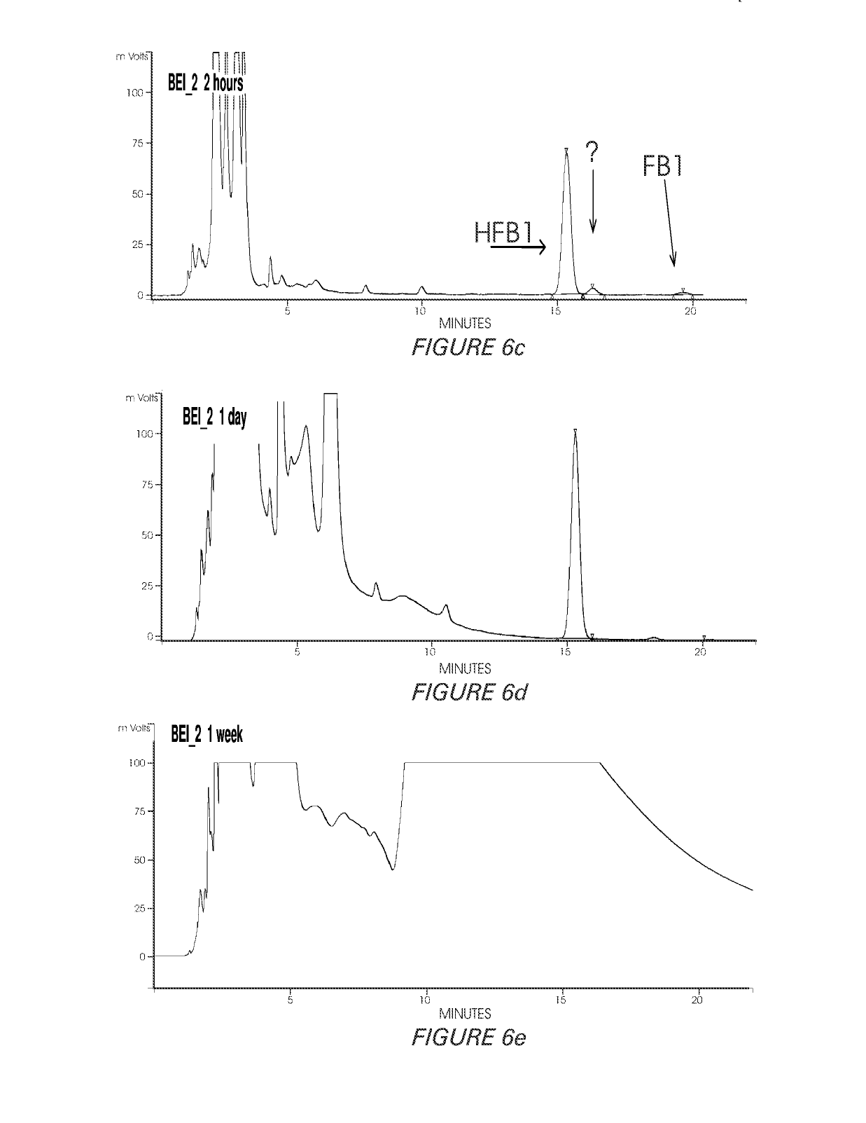

FIGS. 6a, 6b, 6c, 6d and 6e show chromatograms obtained by HPLC-FLD analysis of FB1 in supernatant samples relevant to positive controls, negative controls and decontamination trials with Potentiated Glycerol test material; the efficacy of the Potentiated Glycerol test material (indicated as BEI_{—}2) and reducing mycotoxin content in aqueous solution (2 μg/ml) was assayed at different incubation times (2 hours, 1 day and 1 week).

### EXAMPLE 1

### Assessment of In Vitro Anti-Microbial Activity of a Potentiated Glycerol Solution Against Campylobacter jejuni

The aim of the test was to determine the anti-microbial activity of a Potentiated Glycerol solution (batch ACV280) on Campylobacter jejuni in comparison to a non-potentiated (glycerol-free) saturated, aqueous solution of calcium hydroxide in water (batch ACV235a).

A clear, colourless, semi-viscous, calcium-based Potentiated Glycerol solution (batch ACV280), with a glycerol concentration of 31.2% (w/w) and dissolved hydroxyl ion concentration of 0.35% (w/w) was tested neat and at halving dilutions in sterile distilled water as follows: 1/2, 3/8, 1/4, 1/8, 1/16, 1/32 and 1/64.

Campylobacter jejuni NCTC 11351 was subcultured onto Campylobacter Agar Base plus 5% lysed horse blood (CBA) and the plates incubated at 37° C.±2° C. in a microaerophilic atmosphere for approximately 48 hours. The atmosphere was 5-6% oxygen, 10% carbon dioxide and 84-85% nitrogen, generated by placing the plates in an Oxoid Anaerobic Jar with the Oxoid Gas Generating Kit, Campygen. After this time, surface growth was harvested and directly suspended into sterile distilled water and standardised to give 35-40% light transmission at 520 nm on a Jenway 6105 Spectrophotometer—an approximate yield of 2×10⁸ cfu/ml. A 0.1 ml aliquot of this suspension was inoculated into 9.9 ml of each test substance solution. This was performed in duplicate. At the same time, 1 ml of bacterial suspension was removed from each original stock suspension and placed into 9 ml PBS to perform the initial (Time 0) count, by performing serial ten-fold dilutions in PBS and preparing 0.1 ml spread plates in duplicate on CBA.

The inoculated test substance suspensions were gassed with nitrogen and then shaken for five minutes at room temperature. After this time 1 ml samples of the bacterial suspension were removed from the test containers and placed into 9 ml PBS. For each diluted sample, further serial ten-fold dilutions in PBS down to 10⁻⁴ were made and then used to prepare duplicate 0.1 ml spread plates counts on CBA. Spread plates were also prepared from the neat (undiluted) sample. The plates were incubated at 37° C.±2° C. in the Anaerobic Jar for approximately 48 hours. Following incubation, the plates were counted. Optimally, plates with 30-300 colonies were used to calculate the counts at each sampling time. The results are shown in Table 6.

TABLE 6
Antimicrobial efficacy test
Time 0 count = 4.6 × 10⁶ cfu/ml

| | Dilution | | | | | | Corrected |
|---|---|---|---|---|---|---|---|
| Repli- | of test | Dilution for counting | | | | | count |
| cate | substance | Neat | −1 | −2 | −3 | −4 | cfu/ml |
| 1 | Neat | 0, 0 | 0, 0 | 0, 0 | 0, 0 | 0, 0 | <10 |
| 2 | | 0, 0 | 0, 0 | 0, 0 | 0, 0 | 0, 0 | <10 |
| 1 | ½ | 0, 0 | 0, 0 | 0, 0 | 0, 0 | 0, 0 | <10 |
| 2 | | 0, 0 | 0, 0 | 0, 0 | 0, 0 | 0, 0 | <10 |
| 1 | ¼ | 0, 0 | 0, 0 | 0, 0 | 0, 0 | 0, 0 | <10 |
| 2 | | 0, 0 | 0, 0 | 0, 0 | 0, 0 | 0, 0 | <10 |
| 1 | ⅛ | 0, 0 | 0, 0 | 0, 0 | 0, 0 | 0, 0 | <10 |
| 2 | | 0, 0 | 0, 0 | 0, 0 | 0, 0 | 0, 0 | <10 |
| 1 | 1/16 | 0, 0 | 0, 0 | 0, 0 | 0, 0 | 0, 0 | <10 |
| 2 | | 0, 0 | 0, 0 | 0, 0 | 0, 0 | 0, 0 | <10 |
| 1 | 1/32 | 0, 0 | 50, 69 | 4, 4 | 0, 0 | 0, 0 | 6.0 × 10³ |
| 2 | | 0, 0 | 1, 6 | 0, 0 | 0, 0 | 0, 0 | 3.5 × 10² |
| 1 | 1/64 | TNTC | TNTC | TNTC | 205, 157 | 20, 17 | 1.8 × 10⁶ |
| 2 | | TNTC | TNTC | TNTC | 141, 155 | 8, 10 | 1.5 × 10⁶ |

TNTC: Too numerous to count

The Potentiated Glycerol solution batch ACV280 demonstrated strong anti-microbial activity when tested neat and at dilutions 1/2 to 1/16 against Campylobacter jejuni, with no bacterial counts observed. At the 1/32 dilution, weaker antimicrobial activity was observed, with the numbers of viable test organism reduced from the order of 10⁶ to 10³ cfu/ml. The lowest dilution of 1/64 demonstrated only very weak antimicrobial activity. At the 1/32 dilution, some degree of bacterial growth inhibition was observed in the agar for the neat dilution used for counting. Although bacterial colonies were observed for the 10⁻¹ dilution, no colonies were observed for the neat dilution.

The test showed that Potentiated Glycerol solution batch ACV280 had strong anti-microbial activity (complete kill) when tested neat and at dilutions 1/2 to 1/16 against Campylobacter jejuni.

The test was subsequently repeated using a saturated, aqueous, glycerol-free calcium hydroxide solution batch ACV235a with a dissolved hydroxyl ion concentration of 0.077% w/w. This test showed that the non-potentiated calcium hydroxide solution had a strong anti-microbial activity (complete kill) when tested neat and at dilutions of 1/2 and 1/4. However, the 1/8 and 1/16 dilutions demonstrated only weak anti-microbial activity with the Campylobacter jejuni counts reduced from the order of 10⁶ to 10⁵ cfu/ml.

It was also found that a wet glycerol co-product sample from biodiesel production (ACV293) which has been used as co-solvent for calcium hydroxide in preparation of the potentiated glycerol test solution (ACV280) has shown a limited bactericidal activity against Campylobacter jejuni with the microbial counts being reduced with the undiluted solution from the order of 10⁶ to 10³ cfu/ml and from 10⁶ to 10⁵ cfu/ml at dilutions of 1/2, 1/4, 1/8 and 1/16.

### EXAMPLE 2

### Assessment of Anti-Microbial Activity of Potentiated Glycerol Solutions Versus a Saturated, Aqueous Calcium Hydroxide Solution and a Non-Potentiated Glycerol Solution, Respectively, when Tested Against Salmonella enterica abony

The aim of the test was to determine the anti-microbial activity of three Potentiated Glycerol solutions versus a saturated, aqueous Calcium Hydroxide solution reference and a Non-Potentiated Glycerol solution reference when tested against Salmonella enterica abony.

Five clear, filtered, colourless, calcium-based solutions were tested neat and at halving dilutions in sterile distilled water as follows: 1/2, 3/8, 1/4, 1/8, 1/16, 1/32 and 1/64.

The test solutions were as follows:
1. Potentiated Glycerol solution batch ACV251a (glycerol, 79.0% w/w; dissolved hydroxyl ion concentration, 1.09% w/w)
2. Non-Potentiated Glycerol solution batch ACV251b (glycerol, 80.1% w/w; dissolved hydroxyl ion concentration, 0% w/w) (reference)
3. Potentiated Glycerol solution batch ACV280a (glycerol, 33.7% w/w; dissolved hydroxyl ion concentration, 0.383% w/w)
4. Potentiated Glycerol solution batch ACV280b (glycerol, 29.2% w/w; dissolved hydroxyl ion concentration, 1.92% w/w)
5. Saturated, aqueous Calcium Hydroxide solution batch ACV235a (glycerol, 0% w/w; dissolved hydroxyl ion concentration, 0.077% w/w) (reference)

Salmonella enterica abony

Salmonella enterica abony NCTC 6017 was subcultured onto Tryptone Soya Agar (TSA) and the plates incubated at 37±2° C. for approximately 24 hours. After this time, surface growth was harvested and directly suspended into sterile distilled water and standardised to give 35-40% light transmission at 520 nm on a Jenway 6105 Spectrophotometer—an approximate yield of 2×10⁸ cfu/ml. A 0.1 ml aliquot of this suspension was inoculated into 9.9 mL of each test substance solution to give c. 2×10⁶ cfu/ml. This was performed in duplicate. At the same time, 1 mL of bacterial suspension was removed from the original stock suspension and placed into 9 ml Phosphate Buffered Saline (PBS) to perform the initial (Time 0) count, by performing ten-fold serial dilutions in PBS and then preparing 1 ml pour plates in duplicate on TSA.

The inoculated test substance suspensions were then shaken for five minutes at room temperature. After this time 1 ml samples of the bacterial suspension were removed from the test containers and placed into 9 ml PBS. For each diluted sample, further serial ten-fold dilutions in PBS down to 10⁻⁵ were made and then used to prepare duplicate 1 ml pour plate counts in TSA. Pour plates were also prepared from the neat (undiluted) sample. The plates were incubated at 37±2° C. for approximately 24 hours. Following incubation, the plates were counted. Optimally, plates with 30-300 colonies were used to calculate the counts. The results are shown in Tables 7 to 11.

TABLE 7
Potentiated Glycerol solution batch ACV251a
Time 0 count: 3.1 × 10⁶ cfu/ml

| | Dilution | | | | | | | Corrected |
|---|---|---|---|---|---|---|---|---|
| Repli- | of test | Dilution for counting | | | | | | count |
| cate | substance | Neat | −1 | −2 | −3 | −4 | −5 | cfu/ml |
| 1 | Neat | 0, 0 | 0, 0 | 0, 0 | 0, 0 | 0, 0 | 0, 0 | 0 |
| 2 | | 0, 0 | 0, 0 | 0, 0 | 0, 0 | 0, 0 | 0, 0 | 0 |
| 1 | ½ | 0, 0 | 0, 0 | 0, 0 | 0, 0 | 0, 0 | 0, 0 | 0 |
| 2 | | 0, 0 | 0, 0 | 0, 0 | 0, 0 | 0, 0 | 0, 0 | 0 |
| 1 | ⅜ | 0, 0 | 0, 0 | 0, 0 | 0, 0 | 0, 0 | 0, 0 | 0 |
| 2 | | 0, 0 | 0, 0 | 0, 0 | 0, 0 | 0, 0 | 0, 0 | 0 |
| 1 | ¼ | 0, 0 | 0, 0 | 0, 0 | 0, 0 | 0, 0 | 0, 0 | 0 |
| 2 | | 0, 0 | 0, 0 | 0, 0 | 0, 0 | 0, 0 | 0, 0 | 0 |
| 1 | ⅛ | 0, 0 | 0, 0 | 0, 0 | 0, 0 | 0, 0 | 0, 0 | 0 |
| 2 | | 43, 34 | 0, 0 | 0, 0 | 0, 0 | 0, 0 | 0, 0 | 39 |
| 1 | 1/16 | 11, 1 | 0, 0 | 0, 0 | 0, 0 | 0, 0 | 0, 0 | 6 |
| 2 | | 0, 0 | 0, 0 | 0, 0 | 0, 0 | 0, 0 | 0, 0 | 0 |
| 1 | 1/32 | 34, 10 | TNTC | 138, 152 | 17, 24 | 3, 4 | 1, 1 | 1.5 × 10⁴ |
| 2 | | 3, 0 | TNTC | 186, 207 | 21, 20 | 3, 2 | 1, 0 | 2.0 × 10⁴ |
| 1 | 1/64 | TNTC | TNTC | TNTC | TNTC | 43, 32 | 0, 7 | 3.8 × 10⁵ |
| 2 | | TNTC | TNTC | TNTC | TNTC | 40, 35 | 5, 9 | 3.8 × 10⁵ |

TNTC: Too numerous to count

TABLE 8
Non-Potentiated Glycerol solution batch ACV251b (reference)
Time 0 count: 3.1 × 10⁶ cfu/ml

| | Dilution | | | | | | | Corrected |
|---|---|---|---|---|---|---|---|---|
| Repli- | of test | Dilution for counting | | | | | | count |
| cate | substance | Neat | −1 | −2 | −3 | −4 | −5 | cfu/ml |
| 1 | Neat | TNTC | TNTC | TNTC | TNTC | TNTC | 37, 32 | 3.5 × 10⁶ |
| 2 | | TNTC | TNTC | TNTC | TNTC | TNTC | C | |
| 1 | ½ | TNTC | TNTC | TNTC | TNTC | TNTC | 36, 31 | 3.4 × 10⁶ |
| 2 | | TNTC | TNTC | TNTC | TNTC | TNTC | 37, 39 | 3.8 × 10⁶ |
| 1 | ⅜ | TNTC | TNTC | TNTC | TNTC | TNTC | 33, 30 | 3.2 × 10⁶ |
| 2 | | TNTC | TNTC | TNTC | TNTC | TNTC | 47, 34 | 4.1 × 10⁶ |
| 1 | ¼ | TNTC | TNTC | TNTC | TNTC | TNTC | 42, 31 | 3.7 × 10⁶ |
| 2 | | TNTC | TNTC | TNTC | TNTC | TNTC | 38, 41 | 4.0 × 10⁶ |
| 1 | ⅛ | TNTC | TNTC | TNTC | TNTC | TNTC | 45, 29 | 3.7 × 10⁶ |
| 2 | | TNTC | TNTC | TNTC | TNTC | TNTC | 47, 41 | 4.4 × 10⁶ |
| 1 | 1/16 | TNTC | TNTC | TNTC | TNTC | TNTC | 34, 45 | 4.0 × 10⁶ |
| 2 | | TNTC | TNTC | TNTC | TNTC | TNTC | C | |
| 1 | 1/32 | TNTC | TNTC | TNTC | TNTC | TNTC | 31, 39 | 3.5 × 10⁶ |
| 2 | | TNTC | TNTC | TNTC | TNTC | TNTC | 36, 43 | 4.0 × 10⁶ |
| 1 | 1/64 | TNTC | TNTC | TNTC | TNTC | TNTC | 49, 28 | 3.9 × 10⁶ |
| 2 | | TNTC | TNTC | TNTC | TNTC | TNTC | 37, 38 | 3.8 × 10⁶ |

TNTC: Too numerous to count

TABLE 9
Potentiated Glycerol solution batch ACV280a
Time 0 count: 5.4 × 10⁶ cfu/ml

| | Dilution | | | | | | | Corrected |
|---|---|---|---|---|---|---|---|---|
| Repli- | of test | Dilution for counting | | | | | | count |
| cate | substance | Neat | −1 | −2 | −3 | −4 | −5 | cfu/ml |
| 1 | Neat | 0, 0 | 0, 0 | 0, 0 | 0, 0 | 0, 0 | 0, 0 | 0 |
| 2 | | 0, 0 | 0, 0 | 0, 0 | 0, 0 | 0, 0 | 0, 0 | 0 |
| 1 | ½ | 0, 0 | 0, 0 | 0, 0 | 0, 0 | 0, 0 | 0, 0 | 0 |
| 2 | | 0, 0 | 0, 0 | 0, 0 | 0, 0 | 0, 0 | 0, 0 | 0 |
| 1 | ⅜ | 0, 0 | 0, 0 | 0, 0 | 0, 0 | 0, 0 | 0, 0 | 0 |
| 2 | | 0, 0 | 0, 0 | 0, 0 | 0, 0 | 0, 0 | 0, 0 | 0 |
| 1 | ¼ | 0, 0 | 0, 0 | 0, 0 | 0, 0 | 0, 0 | 0, 0 | 0 |
| 2 | | 0, 0 | 0, 0 | 0, 0 | 0, 0 | 0, 0 | 0, 0 | 0 |
| 1 | ⅛ | 0, 0 | TNTC | TNTC | 18, 24 | 2, 1 | 0, 0 | 2.0 × 10⁴ |
| 2 | | 0, 0 | TNTC | 114, 122 | 12, 8 | 0, 0 | 0, 0 | 1.2 × 10⁴ |
| 1 | 1/16 | TNTC | TNTC | TNTC | TNTC | 103, 121 | 14, 12 | 1.1 × 10⁶ |
| 2 | | TNTC | TNTC | TNTC | TNTC | 121, 87 | 10, 8 | 1.0 × 10⁶ |
| 1 | 1/32 | TNTC | TNTC | TNTC | TNTC | TNTC | 20, 27 | 2.4 × 10⁶ |
| 2 | | TNTC | TNTC | TNTC | TNTC | TNTC | 34, 36 | 3.5 × 10⁶ |
| 1 | 1/64 | TNTC | TNTC | TNTC | TNTC | TNTC | 33, 30 | 3.2 × 10⁶ |
| 2 | | TNTC | TNTC | TNTC | TNTC | TNTC | 51, 38 | 4.5 × 10⁶ |

TNTC: Too numerous to count

TABLE 10
Potentiated Glycerol solution batch ACV280b
Time 0 count: 5.4 × 10⁶ cfu/ml

| | Dilution | | | | | | | Corrected |
|---|---|---|---|---|---|---|---|---|
| Repli- | of test | Dilution for counting | | | | | | count |
| cate | substance | Neat | −1 | −2 | −3 | −4 | −5 | cfu/ml |
| 1 | Neat | 0, 0 | 0, 0 | 0, 0 | 0, 0 | 0, 0 | 0, 0 | 0 |
| 2 | | 0, 0 | 0, 0 | 0, 0 | 0, 0 | 0, 0 | 0, 0 | 0 |
| 1 | ½ | 0, 0 | 0, 0 | 0, 0 | 0, 0 | 0, 0 | 0, 0 | 0 |
| 2 | | 0, 0 | 0, 0 | 0, 0 | 0, 0 | 0, 0 | 0, 0 | 0 |
| 1 | ⅜ | 0, 0 | 0, 0 | 0, 0 | 0, 0 | 0, 0 | 0, 0 | 0 |
| 2 | | 0, 0 | 0, 0 | 0, 0 | 0, 0 | 0, 0 | 0, 0 | 0 |
| 1 | ¼ | 0, 0 | 0, 0 | 0, 0 | 0, 0 | 0, 0 | 0, 0 | 0 |
| 2 | | 0, 0 | 0, 0 | 0, 0 | 0, 0 | 0, 0 | 0, 0 | 0 |
| 1 | ⅛ | 0, 0 | 0, 0 | 0, 0 | 0, 0 | 0, 0 | 0, 0 | 0 |
| 2 | | 0, 0 | 0, 0 | 0, 0 | 0, 0 | 0, 0 | 0, 0 | 0 |
| 1 | 1/16 | 0, 0 | 0, 0 | 0, 0 | 0, 0 | 0, 0 | 0, 0 | 0 |
| 2 | | 0, 0 | 0, 0 | 0, 0 | 0, 0 | 0, 0 | 0, 0 | 0 |
| 1 | 1/32 | 0, 0 | 0, 0 | 0, 0 | 0, 0 | 0, 0 | 0, 0 | 0 |
| 2 | | 0, 0 | 0, 0 | 0, 0 | 0, 0 | 0, 0 | 0, 0 | 0 |
| 1 | 1/64 | TNTC | TNTC | TNTC | TNTC | TNTC | 48, 41 | 4.5 × 10⁶ |
| 2 | | TNTC | TNTC | TNTC | TNTC | TNTC | 39, 46 | 4.3 × 10⁶ |

TNTC: Too numerous to count

TABLE 11
Saturated, aqueous Calcium Hydroxide solution batch ACV235a (reference)
Time 0 count: 5.4 × 10⁶ cfu/ml

| | Dilution | | | | | | | Corrected |
|---|---|---|---|---|---|---|---|---|
| Repli- | of test | Dilution for counting | | | | | | count |
| cate | substance | Neat | −1 | −2 | −3 | −4 | −5 | cfu/ml |
| 1 | Neat | 0, 0 | 0, 0 | 0, 0 | 0, 0 | 0, 0 | 0, 0 | 0 |
| 2 | | 0, 0 | 0, 0 | 0, 0 | 0, 0 | 0, 0 | 0, 0 | 0 |
| 1 | ½ | 0, 0 | TNTC | 71, 69 | 11, 8 | 0, 2 | 0, 0 | 7.0 × 10³ |
| 2 | | 0, 0 | TNTC | 30, 38 | 1, 2 | 0, 0 | 0, 0 | 3.4 × 10³ |
| 1 | ⅜ | 44, 31 | TNTC | TNTC | 126, 137 | 12, 12 | 3, 1 | 1.3 × 10⁵ |
| 2 | | TNTC* | TNTC | TNTC | 276, 306 | 26, 42 | 2, 2 | 2.9 × 10⁵ |
| 1 | ¼ | TNTC | TNTC | TNTC | TNTC | TNTC | 35, 26 | 3.1 × 10⁶ |
| 2 | | TNTC | TNTC | TNTC | TNTC | TNTC | 34, 34 | 3.4 × 10⁶ |
| 1 | ⅛ | TNTC | TNTC | TNTC | TNTC | TNTC | 50, 46 | 4.8 × 10⁶ |
| 2 | | TNTC | TNTC | TNTC | TNTC | TNTC | 55, 41 | 4.8 × 10⁶ |
| 1 | 1/16 | TNTC | TNTC | TNTC | TNTC | TNTC | 62, 44 | 5.3 × 10⁶ |
| 2 | | TNTC | TNTC | TNTC | TNTC | TNTC | 49, 46 | 4.8 × 10⁶ |
| 1 | 1/32 | TNTC | TNTC | TNTC | TNTC | TNTC | 43, 44 | 4.4 × 10⁶ |
| 2 | | TNTC | TNTC | TNTC | TNTC | TNTC | 47, 51 | 4.9 × 10⁶ |
| 1 | 1/64 | TNTC | TNTC | TNTC | TNTC | TNTC | 56, 62 | 5.9 × 10⁶ |
| 2 | | TNTC | TNTC | TNTC | TNTC | TNTC | 53, 51 | 5.2 × 10⁶ |

TNTC: Too numerous to count
*colonies less numerous than −1 and −2 dilutions

Potentiated Glycerol solution batch ACV251a demonstrated strong anti-microbial activity when tested neat and at dilutions down to 1/4 against Salmonella enterica abony, with no bacterial counts observed. At the 1/8 and 1/16 dilutions anti-microbial activity was also observed, with only a few colonies present in one of the two replicates. The 1/32 dilution demonstrated weak anti-microbial activity with the test organism reduced from the order of 10⁶ to 10⁴ cfu/ml. The 1/64 dilution demonstrated weak anti-microbial activity with the test organism reduced from the order of 10⁶ to 10⁵ cfu/ml.

In comparison, the Non-Potentiated Glycerol reference solution batch ACV251b which was prepared from purified water and pharmaceutical grade glycerol demonstrated no anti-microbial activity when tested neat or at any dilution. In an additional experiment the same result (no kill) was obtained with Non-Potentiated Glycerol solution ACV293, a wet glycerol co-product from biodiesel production with a glycerol content of 78.6%.

Potentiated Glycerol solution batch ACV280a demonstrated strong anti-microbial activity when tested neat and at dilutions down to 1/4 against Salmonella enterica abony, with no bacterial counts observed. At the 1/8 dilution, anti-microbial activity was also observed, with the test organism reduced from the order of 10⁶ to 10⁴ cfu/ml. Very weak anti-microbial activity was observed at the 1/16 dilution and no anti-microbial activity was observed at the 1/32 and 1/64 dilutions.

Potentiated Glycerol solution batch ACV280b demonstrated strong anti-microbial activity when tested neat and at dilutions down to 1/32 against Salmonella enterica abony, with no bacterial counts observed. At the 1/64 dilution, no anti-microbial activity was observed.

The saturated, glycerol-free aqueous Calcium Hydroxide reference solution batch ACV235a demonstrated strong anti-microbial activity when tested neat, with no bacterial counts observed. The 1/2 dilution demonstrated moderate anti-microbial activity with the test organism reduced from the order of 10⁶ to 10³ cfu/ml. The 3/8 dilution, demonstrated weak antimicrobial activity, with the test organism reduced from the order of 10⁶ to 105 cfu/ml. However, at the 1/4, 1/8, 1/16, 1/32 and 1/64 dilutions, no anti-microbial activity was observed.

For three of the test substances, Potentiated Glycerol solution batches ACV251a and ACV280a and the aqueous Calcium Hydroxide solution, some degree of bacterial growth inhibition was observed in the agar for the neat dilution used for counting. Therefore, instead of ten fold reductions in the bacterial counts being observed for the dilution series of neat to 10⁻⁵, very high bacterial counts were observed for the 10⁻¹ dilution, but few or even no colonies were observed for the neat dilution.

Four of the five test solutions therefore demonstrated anti-microbial activity when tested against Salmonella enterica abony. In order of potency they were ranked as follows:

Potentiated Glycerol solution batch ACV280b>
Potentiated Glycerol solution batch ACV251a>
Potentiated Glycerol solution batch ACV280a>
Aqueous, glycerol-free calcium hydroxide solution batch ACV235a

The Non-Potentiated Glycerol reference solution batch ACV251b demonstrated no anti-microbial activity when tested neat or at any dilution. The observed trends are in agreement with the respective solubilised hydroxyl ion concentrations of the test solutions.

### EXAMPLE 3

### In Vitro Testing of a Potentiated Glycerol Solution Against Pathogenic Fruit Fungi, Monilinia laxa and Botrytis cinerea

The objective of the test was to assess the anti-fungal activity of Potentiated Glycerol solution batch ACV280 in confining germination and restricting germ-tube growth of Monilinia laxa and Botrytis cinerea using the raised cover slip quantification method.

A clear, colourless, semi-viscous, calcium-based Potentiated Glycerol solution (batch ACV280), with a glycerol concentration of 31.2% (w/w) and dissolved hydroxyl ion concentration of 0.35% (w/w) was tested neat and at halving dilutions in sterile distilled water as follows: 1/2, 3/8, 1/4, 1/8, 1/16 and 1/32.

### Treatments:

1. ACV280 at 1:2 dilution with spore suspension of 200 000 spores/ml
2. ACV280 at 1:4 dilution with spore suspension of 200 000 spores/ml
3. ACV280 at 1:8 dilution with spore suspension of 200 000 spores/ml
4. ACV280 at 1:16 dilution with spore suspension of 200 000 spores/ml
5. ACV280 at 1:32 dilution with spore suspension of 200 000 spores/ml
6. Control/non-amended spore suspension of 200 000 spores/ml

Spore suspension of ±200 000 spores/ml water of Botrytis cinerea, Monilinia laxa were prepared, followed by the dilutions as indicated above. A droplet of 25 μl of the diluted product and spore suspension was pipetted onto a microscope slide. A cover slip, supported at both ends on microscope slide pieces, was placed above the droplet and touched lightly to entrap the suspension droplet between the microscope slide at the bottom and the cover slip at the top. The microscope slides with the entrapped suspension droplets were placed in a container at a high humidity of ±95% for the incubation period of 12 hours. The supporting pieces were removed after 12 hours, entrapping the suspension directly onto the microscope slide for assessment by light microscopy.

Assessment by light microscopy of the following was performed in each instance:

1. Germination (%), by counting the number of spores germinating for a sub-sample of 50 spores, in at least 4 different microscope fields.
2. Germ-tube growth (μM), by measuring the length of the germ-tubes emerging from the germinating conidia.
3. Budding (%), by counting the number of spores exhibiting budding tips, but not proper germination, in the same 4 microscope fields as where the sub-sample of 50 spores were assessed for germination.

The data were analysed as a one-way ANOVA. Treatment means of 4 replicate counts of 4 microscope fields each, were compared to establish significant differences between treatments, according to the LSD test (P<0.05).

The results obtained for treatment of Botrytis cinerea with dilutions of potentiated glycerol solution ACV280 are depicted in Table 12.

TABLE 12
Efficacy of Potentiated Glycerol solution ACV280 in confining the
germination of Botrytis cinerea as assessed after 12 h incubation at
20° C. at a high relative humidity

| | Microscopy assessment | | |
|---|---|---|---|
| | Germination | Budding | Germ-tube |
| Treatment | (%) | (%) | length (μM) |
| ACV280 @ 1:2 | 0.0a | 4.3a | 0.0a |
| ACV280 @ 1:4 | 2.1ab | 6.1a | 1.0a |
| ACV280 @ 1:8 | 7.4ab | 8.3ab | 4.1b |
| ACV280 @ 1:16 | 12.0b | 12.9bc | 4.5bc |
| ACV280 @ 1:32 | 34.3c | 18.8d | 5.9c |
| Control (non-amended) | 78.7d | 15.7cd | 16.1d |
| Probability* | 0.0000 | 0.0000 | 0.0000 |

*One-way ANOVA. Values within each column, followed by different letters, indicate significant difference according to the LSD-test for P < 0.05

Botrytis cinerea: Observations and Conclusions:

Germination was significantly reduced by all dilutions, compared to the non-amended control. Germination was significantly higher for the 1:32 dilution compared to the other dilutions tested. Germination was totally inhibited with the 1:2 dilution, resulting in a significant lower germination level than the 1:16 dilution. Inhibition of germination was related to the dilution factor.

Budding, the early sign of possible germination, or prevention of proper germination, was significantly lower at the reduced dilution rates of 1:2 and 1:4, compared to dilution at 1:16 and 1:32, as well as the non-amended control. Budding was also significantly lower at the 1:8 dilution level, compared to treatment with the 1:32 dilution.

Germ-tube length was significantly confined by all dilutions, compared to the non-amended control. Germ-tube length was significantly lower for treatments at the 1:2 and 1:4 dilutions, compared to dilution at 1:8 and higher. Inhibition of germ-tube growth was related to the dilution factor.

The results obtained for treatment of Monilinia laxa with dilutions of potentiated glycerol solution ACV280 are depicted in Table 13.

TABLE 13
Efficacy of Potentiated Glycerol solution ACV280 in confining the
germination of Monilinia laxa as assessed after 12 h incubation at
20° C. at a high relative humidity

| | Microscopy assessment | | |
|---|---|---|---|
| | Germination | Budding | Germ-tube |
| Treatment | (%) | (%) | length (μM) |
| ACV280 @ 1:2 | 0.0a | 3.1b | 0.0a |
| ACV280 @ 1:4 | 0.0a | 7.0cd | 0.0a |
| ACV280 @ 1:8 | 4.2ab | 6.1bc | 4.4ab |
| ACV280 @ 1:16 | 9.2b | 12.1e | 9.3b |
| ACV280 @ 1:32 | 24.2c | 10.0de | 19.8c |
| Control (non-amended) | 86.0d | 0.0a | 60.1d |
| Probability* | 0.0000 | 0.0000 | 0.0000 |

*One-way ANOVA. Values within each column, followed by different letters, indicate significant difference according to the LSD-test for P < 0.05

Monilinia laxa: Observations and Conclusions:

Germination was significantly reduced by all dilutions, compared to the non-amended control. Germination was significantly higher for the 1:32 dilution, compared to all other dilutions tested. Germination was completely inhibited by the 1:2 and 1:4 dilutions, resulting in a significant lower germination level than the 1:16 dilution. Inhibition of germination was related to the dilution factor.

Significant differences between treatments were exhibited for budding, but did not relate, as with Botrytis cinerea, to the dilution factor.

Germ-tube length was significantly confined by all dilutions, compared to the non-amended control. Germ-tube length was significantly lower by treatment with the 1:2 and 1:4 dilutions, compared to dilutions of 1:16 and higher. Inhibition of germ-tube growth was related to the dilution factor.

It is concluded that potentiated glycerol solution ACV280 showed efficacy in confining germination and germ-tube growth of Botrytis cinerea and Monilinia laxa. The neat solution and dilution factors of 1:4 or 1:8 of the test material were sufficient in the in vitro study for effective reduction of germination of Botrytis cinerea and Monilinia laxa.

### EXAMPLE 4

### In Vitro Testing of a Potentiated Glycerol Solution Against Mycotoxins (Aflatoxin B1 (AFB1), Ochratoxin A (OTA), Zearalenone (ZEA), Fumonisin B1 (FB1), Deoxynivalenol (DON), and HT-2/T-2 Toxins (HT-2/T-2)) in Aqueous Medium

This test was aimed at assessing the efficacy of a dilute Potentiated Glycerol solution in reducing the mycotoxin concentration of a multi-toxin aqueous solution containing aflatoxin B1 (AFB1), ochratoxin A (OTA), zearalenone (ZEA), fumonisin B1 (FB1), deoxynivalenol (DON), and HT-2/T-2 toxins (HT-2/T-2).

The test also evaluated the effect of the retention time of the process on the rate and extent of mycotoxin reduction. To assess the simultaneous reduction of toxins, the mixture of mycotoxins at 2 μg/ml was mixed with the test material, and at a fixed temperature (37° C.) and time of reaction. The effect of three reaction times (2 hours, 1 day and 1 week) on each toxin concentration was assessed.

Potentiated glycerol powder ACV188a (500 mg), which was prepared from calcium oxide and wet, biodiesel by-product glycerol according to the method described in PCT/IB2009/052931 as a source of solubilised calcium hydroxide and glycerol when mixed with water, was weighed in an 8 ml amber tube.

Extraction (mixing followed by filtration of the suspension) of 8 gram calcium-glycerol powder ACV188a with 100 ml water at room temperature in a separate experiment gave ACV255, a clear, transparent aqueous solution of calcium hydroxide and glycerol with a glycerol content of 10% (w/w) and solubilised calcium hydroxide content of 0.39% (w/w) (calcium, 0.21% w/w; hydroxide, 0.18% w/w). This (0.39% w/w) exceeded the maximum amount of solubilised calcium hydroxide (0.17%) in a saturated calcium hydroxide solution at room temperature due to the enhanced solubilisation effect which is facilitated by the presence of the extracted glycerol in solution.

A 5 ml aqueous mycotoxin working solution (2 μg/ml) was added to the tube (giving a final product dosage of 10% w/v, an aqueous suspension) and vigorously mixed by vortex for few seconds to ensure that the material dispersed evenly (checked visually).

The suspension of the powder in the mycotoxin solution was shaken in a thermostatically controlled shaker at 37° C. (±0.5), at a speed of 250 rpm for different times (2 hours, 1 day or 1 week). After the incubation period, the suspension of was transferred into a 10 ml pyrex tube and centrifuged for 20 min at 4000 rpm and at 25° C. Then, a 1400 μl supernatant was transferred into a silanised glass amber vial and diluted with a 600 μl mixture of acetonitrile+methanol (1+2, v+v) containing acetic acid 1%.

Supernatants (1400 μl) of the negative controls were diluted with 600 μl mixtures of acetonitrile+methanol (1+2, v+v) without acetic acid. All diluted samples were filtered with micro spin cellulose regenerate filter tubes (RC/G), 0.2 μm (Grace Davison Discovery Science, IL, USA). The filtered samples were split in 3 aliquots and prepared for analysis of residual mycotoxin content by High Performance Liquid Chromatography (HPLC) for FB1 and by Ultra Performance Liquid Chromatography (UPLC) for determination of AFB1, ZEA, OTA, DON, T-2 and HT-2.

Mycotoxin standards (purity >99%) were supplied by Sigma-Aldrich (Milan, Italy). All chemicals used were of analytical grade unless otherwise stated. All solvents (HPLC grade) were purchased from J. T. Baker (Deventer, The Netherlands). Water was of Milli-Q quality (Millipore, Bedford, Mass.).

Stock solutions of mycotoxins (1 mg/ml) were prepared by dissolving the pure crystals of AFB1, OTA, ZEA, DON, T-2 and HT-2 in acetonitrile, whilst the pure crystals of FB1 were dissolved in acetonitrile-water (50+50, v+v). The actual concentration of mycotoxin stock solutions was verified by UV-vis spectrophotometric analysis or by high performance liquid chromatography (HPLC) analysis using certified standard solutions. Certified standard solutions of OTA (10 μg/ml in acetonitrile), T-2 and HT-2 toxins (100 μg/ml in acetonitrile) and FB1 (50 μg/ml in acetonitrile+water, 50+50, v+v) were supplied by Biopure (Tulln, Austria).

The AOAC Official Methods of Analysis (2000), the methods of Joseph et al. (2004), and Krska et al. (2007) were used to analyse the 1 mg/ml stock solution of AFB1, ZEA, and DON, respectively. Standard solutions at 10 μg/ml were prepared for AFB1 and ZEA, and at 25 μg/ml for DON by properly diluting stock solutions with acetonitrile.

The concentration of standard solutions was determined by measuring absorbance at wavelength of maximum absorption close to 350 nm, 274 nm and 220 nm for AFB1, ZEA, and DON, respectively.

The following equation was applied to calculate mycotoxin concentrations:

Mycotoxin (μg/ml)=(A×MW×1000)/ε, in which
A=absorbance (mean of 6 replicate measurements),
MW=molecular weight (312, 318.4, and 296.3 for AFB1, ZEA, and DON, respectively),
ε=molecular absorptivity (20700, 12623 and 6805 for AFB1, ZEA, and DON, respectively).

A multi-mycotoxin standard solution, containing 100 μg/ml of AFB1, ZEA, FB1, OTA, T-2, HT-2 and DON, was prepared by mixing equal volumes (2 ml) of mycotoxin stock solutions (1 mg/ml) and diluting to 20 ml by acetonitrile.

To prepare the multi-toxin working solution (200 ml final volume) for adsorbing/decontamination experiments, a 4 ml-volume of the multi-toxin standard solution (100 μg/ml) was properly diluted to 2 μg/ml by using distilled water.

In order to avoid variability in the experimental data, 200 ml-mycotoxin working solution in water was prepared just before application and used for all materials as described below. For each set of trials, a control treatment without adsorbent (negative control) was prepared by using the same volume of mycotoxin working solution. This was subjected to the same test procedure, and served as a background control during the analysis to investigate the stability of mycotoxins in water solution or any possible non-specific adsorption on the surfaces of the vessels.

Positive controls of Potentiated Glycerol without mycotoxins were processed as the test samples. These were used to investigate any component of materials that can interfere with chromatographic analysis of mycotoxins.

All experiments, including negative and positive controls, were performed in triplicate, at 37° C. and in the dark to protect mycotoxins from UV light.

Residual DON, AFB1, ZEA and OTA in supernatant samples obtained from multi-toxin decontamination trials were simultaneously analyzed by UPLC, coupled with photodiode array (PDA) and spectrofluorometric (FLR) detectors.

Residual T-2 and HT-2 in supernatant samples were simultaneously analysed by UPLC, coupled with a photodiode array (PDA) detector.

For FB1 determination, aliquots of diluted supernatant samples were analysed by HPLC-FLD system and required pre-column derivatisation by OPA reagent. The UPLC apparatus was a Waters Acquity Ultra Performance LC™ system (Miliford, Mass., USA) equipped with a B09UPB binary pump, M08UPA sample manager (with loop suitable for 1-10 μL injections), A09UPH column thermostat, K08UPF spectrofluorometric detector, A09UPD photodiode array detector and Empower Pro2 Chemstation operating system.

The HPLC apparatus was an Agilent 1100 series HPLC, equipped with a binary pump, autosampler (with loop suitable for 10-50 μl injections), column thermostat, spectrofluorometric detector, PDA detector and Agilent Chemstation G2170AA Windows 2000 operating system (Agilent, Waldbronn, Germany). Chromatographic conditions for mycotoxin analyses were as described hereafter.

The analytes DON, AFB1, ZEA and OTA were simultaneously determined by separation on a Waters Acquity BEH C18 column (100×2.1 mm i.d., 1.7 μm particle). Chromatographic separation of mycotoxins was achieved through a 13.5 min gradient delivery of a mixture of A (water+acetonitrile, 85+15 v/v) and B (methanol+acetonitrile 50+50 v/v, containing 0.5% acetic acid) at a flow rate of 0.4 ml/min.

The UV absorption spectra of mycotoxins were recorded in the range of 190-400 nm. UV absorbance data were collected with a bandwidth of 1.2 nm and without digital filtering, at wavelengths of 220 nm for DON and 350 nm for AFB1. For UV-analysis of these toxins, detection wavelength was switched during the chromatographic run according to their retention time. Thus, LC UV-chromatogram was acquired at 220 nm absorbance wavelength for the first 3 min, and then at 350 nm.

For fluorescence detection of AFB1, ZEA and OTA, programmable wavelength switching was also used to optimize excitation and emission response, thereby improving sensitivity for individual toxins and minimizing interferences. Detection was carried out using a wavelength program with, respectively, excitation and emission wavelengths of 333 and 460 nm until 7.5 min for AFB1 detection, then of 274 and 440 nm from 7.5 to 8.5 min for ZEA, and of 333 and 460 nm from 8.5 to 13.5 min for OTA. UPLC calibration was based on three replicate analyses of 5 calibrant solutions ranging from 0.1 to 4 μg/ml and prepared in mixture of water+acetonitrile+methanol (70+10+20, v/v/v). The limit of quantification (LOQ) was calculated from an S/N ratio equal to 10.

The analytes T-2 and HT-2 were simultaneously determined by separation on a Waters Acquity BEH C18 column (50×2.1 mm i.d., 1.7 μm particle). Chromatographic separation of T-2 and HT-2 was achieved through a 10 min gradient delivery of a mixture of A (water) and B (acetonitrile) at a flow rate of 0.7 ml/min.

Before UPLC analysis, T-2/HT-2 samples in distilled water were properly diluted with organic modifiers in order to increase the sensitivity of the method. Due to the high sensitivity of the UPLC method of analysis, pre-column derivatisation of HT-2/T-2 samples was not required.

UPLC calibration was based on three replicate analyses of 5 calibrant solutions ranging from 0.1 to 4 μg/ml and prepared in mixture of water+acetonitrile+methanol (70+10+20, v/v/v). The LOQ was calculated from a S/N ratio equal to 10.

Chromatographic separation of FB1 toxin was achieved through a Kinetex PFP analytical column, 100×4.6 mm i.d., 2.6 μm particle sizes (Phenomenex, Castel Maggiore, BO, Italy) thermostatted at 30° C. Isocratic mobile phase consisted of the mixture water+methanol+acetonitrile (50+25+25, v/v/v) containing acetic acid (1%), and eluted at 0.8 ml/min flow rate for 20 min.

After toxin elution, the column was washed for 3 min by 95% acetonitrile in mobile phase. The fluorescence detector was set at 335 nm (λex) and 440 nm (λem). Prior to HPLC analysis, FB1 samples were pre-column derivatised with o-phthaldialdehyde (OPA) reagent. OPA reagent was prepared by dissolving 40 mg OPA with 1 mL methanol and 5 ml sodium tetraborate (Na₂B₄O₇*12H₂O, 0.1 mol/l). Then, 50 μL 2-mercaptoethanol were added and mixed for 1 minute.

This reagent solution was stable for up to one week at room temperature in dark, capped amber vial. FB1 derivatisation was performed using an automated pre-column derivatisation programme. In particular, 110 μl-volume of filtered supernatant sample was transferred to an HPLC autosampler vial containing glass flat bottom vial insert, and then vigorously mixed with 220 μl of OPA reagent. After 2.5 min derivatisation time, 50 μl derivatised sample was injected into HPLC system in fool loop mode.

HPLC calibration was based on three replicate analyses of 5 calibration solutions ranging from 0.1 to 4 μg/ml and prepared in mixture of water+acetonitrile+methanol (70+10+20, v/v/v). The LOQ was calculated from a S/N ratio equal to 10.

The adsorption/degradation of mycotoxins is generally defined as the percentage of mycotoxin adsorbed or degraded by detoxifying agents related to the quantity present at the beginning of the test, under the test conditions. In the tests, the amount of bound/degraded mycotoxin was calculated as the difference between the amount of mycotoxin in the supernatant of the negative control samples with no test product and the amount found in the supernatant of the experimental tubes with the detoxifying agents. This amount was then related to the quantity present in the supernatant of the negative controls and expressed in percent.

It was shown that, UPLC, a very fast and sensitive technique, could be applied to the simultaneous determination of DON, AFB1, ZEA and OTA by FLD/PDA detection, and to simultaneous determination of T-2 and HT-2 by PDA detection. All LC-methods of analysis for mycotoxins used (HPLC/UPLC) were sensitive, and showed a good selectivity, accuracy, and precision.

Representative UPLC chromatograms obtained from a multi-toxin standard solution containing DON, AFB1, ZEA and OTA at 2 μg/ml are shown in FIG. 1. The mycotoxins of interest were well resolved in 10 min, and showed retention times at 2.2 min for DON, 4.5 min for AFB1, 8.6 min for ZEA and 9.3 min for OTA. DON and OTA were detected by PDA. AFB1 and ZEA were detected using both PDA and FLD detectors.

The UPLC-PDA chromatogram obtained from a multi-toxin standard solution containing HT-2 and T-2 (2 μg/ml) is shown in FIG. 2. HT-2 and T-2 were resolved in less than 5 minutes and showed retention times at 3.4 minutes and 4.3 minutes, respectively.

The HPLC-FLD chromatogram of a multi-toxin standard solution containing FB1 (2 μg/ml) is shown in FIG. 3. The retention time for FB1 was 20 min.

UPLC and HPLC methods for mycotoxin analysis were linear in the concentration range of 0.1-4.0 μg/ml (five mycotoxin levels, n=3).

Liquid chromatographic methods were selective and no compound interfered with the identification and quantification of mycotoxin peaks. HPLC/UPLC analyses of positive controls prepared for the test material at different times showed no peak interfering with mycotoxin analysis (refer to chromatograms in FIGS. 4-6).

During the HPLC/UPLC runs and after isocratic elution of compounds, a min washing step with 80-90% acetonitrile in mobile phase was added in order to wash the columns. This allowed shortening the time of HPLC/UPLC runs and cleaned-up columns from interfering compounds retained by the stationary phase. Consequently, separation of compounds was very fast and with sufficient resolution.

For all mycotoxins and the test material assayed in the investigation, no clean-up (by using a solid phase extraction or immunoaffinity column) of supernatants was required after decontamination experiments and prior to HPLC/UPLC analysis. No post-column derivatisation of AFB1 or T-2/HT-2 toxins was needed to increase detectability and/or selectivity of response for the UPLC detectors. This notably reduced the time of analysis.

At the end of the decontamination trials, supernatant samples relevant to the Potentiated Glycerol solution showed an alkaline pH. Prior to HPLC or UPLC analysis, these samples were properly diluted by mixing 1400 μl sample (in aqueous solution) with 600 μl mixture of acetonitrile+methanol (1+2, v+v) containing acetic acid 1%, and then filtered using cellulose regenerate micro-filters.

The addition of organic solvents to aqueous solution of toxins was required in order to enhance sensitivity of the analytical methods. Moreover, it was observed that reconstitution of samples with organic modifiers prevented unspecific adsorption of toxins to the filter membranes.

Finally, the addition of acetic acid to these supernatant samples decreased the pH of the samples, thus lowering pH values from >10 to about 7. Supernatants of negative control samples (multi-toxin working solution in water without test material) were also diluted by mixture of organic solvents (acetonitrile+methanol 1+2, v+v), but the addition of acetic acid was not needed as they had neutral pH.

HPLC/UPLC chromatograms obtained by LC analysis of diluted and filtered supernatant samples relevant to positive controls, negative controls and test material are shown in FIGS. 4-6.

The efficacy of the test material in reducing mycotoxin content in aqueous solution (2 μg/ml) was assayed at different incubation times. The HPLC/UPLC chromatograms obtained at these treatment times are shown in FIGS. 4-6.

The results of the investigation are summarised in Table 14, which lists relative amounts of mycotoxins remaining in aqueous solution after 2 hours, 1 day and 1 week treatment with the Potentiated Glycerol test substance. Mycotoxin recoveries are expressed in percent and are calculated with respect to negative control samples analysed simultaneously. Results are averages (±SD) of triplicate experiments.

TABLE 14
Reduction in mycotoxin content of a multi-toxin aqueous solution
(2 μg/ml) by treatment at 37 degrees Celsius with a potentiated
glycerol liquid for 2 hours, 1 day and 1 week, respectively.

| | | MYCOTOXIN RECOVERIES (%) | | | | | |
|---|---|---|---|---|---|---|---|
| PROD- | | Mean ± SD (n = 3) | | | | | |
| UCT | Time | AFB1 | ZEA | OTA | DON | FB1 | HT-2/T-2 |
| Poten- | 2 h | 64 ± 1 | 38 ± 1 | 0 ± 0 | 43 ± 0 | 2 ± 0 | 0 ± 0 |
| tiated | 1 day | 16 ± 0 | 0 ± 0 | 0 ± 0 | 0 ± 0 | 0 ± 0 | 0 ± 0 |
| Glyc- | 1 week | 0 ± 0 | 0 ± 0 | 0 ± 0 | 0 ± 0 | 0 ± 0 | 0 ± 0 |
| erol | | | | | | | |

As shown in Table 14, the liquid potentiated glycerol test material was effective in simultaneously reducing the levels of all mycotoxins present in the aqueous solution.

Four toxins, out of 7 mycotoxins assayed, i.e. FB1, OTA, T-2 and HT-2 were especially unstable under alkaline conditions obtained by treatment with potentiated glycerol. Reduction of some toxins was a rapid process, as OTA, T-2 and HT-2 were undetectable in supernatant samples after the first assessed contact time of only 2 hours. Total destruction of DON and ZEA was achieved after 1 day treatment with 84% reduction achieved for AFB1. Prolonged incubation time (1 week) gave complete reduction in the levels of all mycotoxins.

The degradation products of the observed mycotoxin destructions are unknown. With the exception of FB1 (which was hydrolyzed to HFB1), no major increasing chromatographic peaks coinciding with the decline of mycotoxins were observed.

The invention provides a method for the rapid reduction of mycotoxins. The 1 day and 1 week treatment with the dilute potentiated glycerol composition reduced all mycotoxin levels below the quantification limits of the liquid chromatography (LC) method used with the exception only of aflatoxin B1, which was reduced by 84% after a contact time of 1 day (Table 14). As expected, mycotoxin reduction in aqueous solution was higher after longer contact times. The 1 day decontamination treatment completely reduced OTA, DON, FB1, T2 and HT-2 toxins. Prolonged incubation time (1 week) gave complete reduction of all mycotoxin contents.

The Applicant is of the view that potentiated Glycerol Compositions such as the relatively dilute test material assessed as well as more concentrated formulations thereof, will be effective in proportionally smaller doses as a function of the solubilised hydroxyl ion concentrations therein to achieve similar mycotoxin destruction efficacies and have a useful application as a functional feed ingredient in decontaminating multi-mycotoxin contaminated grains and feeds.

### EXAMPLE 5

### In Vitro Testing of a Potentiated Glycerol Solution Against Mycotoxins Zearalenone (ZEA) and HT-2 Toxin (HT-2) in an Animal Feed Matrix

The relative mycotoxin detoxifying effect of Potentiated Glycerol solution ACV294a (calcium hydroxide content 2.31% (w/w), glycerol content 78.4% (w/w)) undiluted and 1:1 diluted in water versus a (glycerol-free) 25% (w/w) calcium hydroxide reference suspension in water against zearalenone and HT-2 toxin, respectively, was evaluated in corn as animal feed matrix.

The moisture content of the corn was adjusted to 14% (w/w). The treatment agents were applied at 5% onto the corn, except the 1:1 diluted agents, which were applied at 10% (resulting in 5% active material). The final moisture content of all samples was between 13 and 17%.

After 24 hours incubations, the mycotoxins were extracted from the feed and the extracts were analysed by HPLC.

The results depicted in Table 15 are presented as mycotoxin percentage decrease.

TABLE 15
Decrease in mycotoxin content (%) on a feed matrix after treatment with
a potentiated glycerol solution versus calium hydroxide control,
respectively, for 24 hours

| | | ZEA | HT-2 |
|---|---|---|---|
| | Amount (%) of | content | content |
| | calcium hydroxide | decrease | decrease |
| | added in treatment | (%) | (%) |
| Potentiated Glycerol | 0.05 × 2.31 = | 58 | 58 |
| Solution ACV294a | 0.1155% | | |
| (calcium hydroxide, | | | |
| 2.31%; glycerol, | | | |
| 78.4%) | | | |
| Potentiated Glycerol | 0.2 × 1.155 = | 47 | 62 |
| Solution ACV294a | 0.1155% | | |
| diluted in water | | | |
| (calcium hydroxide, | | | |
| 1.155%; glycerol, | | | |
| 37.25%) | | | |
| Calcium hydroxide | 0.05 × 25 = | 42 | 50 |
| suspension in water | 1.25% | | |
| (calcium hydroxide, | | | |
| 25%; glycerol, 0%) | | | |

As shown in Table 15, the potentiated glycerol solutions applied at an effective dose of 0.1155% (w/w) calcium hydroxide was more effective in reducing the levels of both zearalenone and HT-2 toxin in the corn feed matrix compared to the glycerol-free calcium hydroxide control at a 10.8-fold higher dose of 1.25% (w/w) calcium hydroxide as tested.

### EXAMPLE 6

### Assessment of In Vitro Anti-Microbial Activity of a Potentiated Glycerol Solution Against Biofilms of Staphylococcus aureus, Pseudomonas aeruginosa and Candida albicans

The aim of this experiment was to first determine the minimum inhibitory concentrations (MICs) of a clear Potentiated Glycerol solution (batch ACV313b) with a glycerol concentration of 75.3% (w/w) and dissolved calcium hydroxide concentration of 2.04% (w/w) against planktonic cells of Staphylococcus aureus, Pseudomonas aeruginosa and Candida albicans, respectively, in comparison to a non-potentiated (glycerol-free), aqueous solution of calcium hydroxide in water (batch ACV316) as control with a dissolved calcium hydroxide concentration of 0.078% (w/w).

This was followed by testing of the most potent antimicrobial solution (potentiated glycerol) at the determined minimum inhibitory concentrations in biofilm experiments wherein the activity of the potentiated glycerol solution (ACV313b) against glycerol as reference was determined against biofilms of the microbial strains.

The MIC results are depicted in Table 16.

TABLE 16
Minimum inhibitory concentrations (MICS) of the test substance
(ACV313b) and the control (ACV316) for Staphylococcus aureus,
Pseudomonas aeruginosa and Candida albicans

| | Candida | Staphylococcus | Pseudomonas |
|---|---|---|---|
| | albicans | aureus | aeruginosa |
| Potentiated Glycerol | 12.5% | 3.1% | 6.25% |
| Solution ACV313b | | | |
| (calcium hydroxide, | | | |
| 2.04%; glycerol, 75.3%) | | | |
| Saturated, aqueous | 25% | >50% | >50% |
| Calcium Hydroxide | | | |
| solution ACV316 | | | |
| (calcium hydroxide, | | | |
| 0.078%; glycerol, 0%) | | | |

From the MIC results shown in Table 16 it is clear that the potentiated glycerol solution (ACV313b) with solubilised calcium hydroxide content of 2.04% (w/w) exhibited a significantly stronger response against the planktonic microbial cells compared to the glycerol-free (non-potentiated), calcium hydroxide solution control (ACV316) with calcium hydroxide content of 0.078%. This is ascribed to the enhanced solubilisation effect of calcium hydroxide in the aqueous medium which is facilitated by glycerol. The maximum solubility of calcium hydroxide in (glycerol-free) water is about 0.17% (w/w) i.e. about 12 times less than the solubilised calcium hydroxide content of (non-optimised) potentiated glycerol solution ACV313b as tested.

Biofilms of Staphylococcus aureus, Pseudomonas aeruginosa and Candida albicans were subsequently produced over 24 hours in microtitre plates. Aliquots of 100 μl of potentiated glycerol solution ACV313b and glycerol as reference, respectively, were added to the wells, and incubated 5 min. Resazurin viability staining was applied and fluorescence of the biofilms measured.

The results of this experiment are summarised in Table 17. The data are fluorescence per well (average±S.D.) obtained after resazurin-based viability staining. A lower signal means less surviving cells.

TABLE 17
Activity of Potentiated Glycerol solution (ACV313b) and Glycerol
against microbial biofilms

| | Treatment | | |
|---|---|---|---|
| Micro- | | Potentiated | |
| organism | Control (none) | Glycerol (w/v) | Glycerol (w/v) |
| S. aureus | 160,000^{a}* ± 40,000 | 60,000^{b} ± 60,000 | 180,500^{a} ± 30,000 |
| | | (3.1%) | (10.0%) |
| P. aeruginosa | 25,000^{a} ± 8,500 | 0^{b} | 29,000^{a} ± 30,000 |
| | | (6.25%) | (10.0%) |
| C. albicans | 130,000^{a} ± 12,000 | 30,000^{b} ± 7,500 | 150,000^{a} ± 17,800 |
| | | (12.5%) | (10.0%) |

*Means with different superscripts in the same row are different P < 0.00001
A significant effect of the potentiated glycerol solution (ACV313b) at the indicated minimum inhibitory concentrations against the biofilms of the selected micro-organisms was observed. Glycerol on its own actually supported the growth of the micro-organisms.

### EXAMPLE 7

### In Vitro Testing of a Potentiated Glycerol Compositions Against Endotoxins in Aqueous Medium

Preliminary in vitro assessment of the endotoxin-destruction effect of liquid and solid Potentiated Glycerol compositions, respectively, in aqueous medium using the Limulus Amoebocyte Lysate (LAL) test has shown very significant decreases in endotoxin concentrations. The LAL test focuses in particular on 2-keto-3-deoxyoctonoic acid, which is used as an indicator in the majority of endotoxin assays.

### REFERENCES

1. Glycerine: an overview by the Soap and Detergent Association (SDA)—Glycerine & Oleachemical Division, 475 park Avenue South, New York, N.Y. 10016 (1990) and references therein.
2. Cerrate, S., Yan, F., Wang, Z., Coto, C., Sacakli, P., Waldroup, W. (2006). Evaluation of glycerine from biodiesel production as a feed ingredient for broilers. International Journal of Poultry Science, 5: 1001-1007.
3. Gunn, P. J., Neary, M. K., Lemenager, R. P. and Lake S. L. (2010). Effects of crude glycerin on performance and carcass characteristics of finishing wether lambs. Journal of Animal Science, 88: 1771-1776.
4. Lammers, P. J. Kerr B. J., Weber T. E., Bregendahl, K. S., Lonergan, M., Prusa K. J., Ahn, D. U., Stoffregen, W. C., Dozier III, W. A. and Honeyman M. S. (2008). Growth performance, carcass characteristics, meat quality, and tissue histology of growing pigs fed crude glycerin-supplemented diets. Journal of Animal Science, 86: 2962-2970.
5. Schieck, S. J., Kerr, B. J., Baidoo, S. K., Shurson, G. C., and Johnston, L. J. (2010) Use of crude glycerol, a biodiesel co-product, in diets for lactating sows. Journal of Animal Science, (in press).
6. Schröder, A. and Südekum, K-H. (1999). Glycerol as a by-product of biodiesel production in Diets for ruminants. 10^{th} International Rapeseed Congress, Canberra, Australia, p 6 and Südekum, K-H, Schröder, A, Fiebelkorn, S, Schwer, R and. Thalmann, A. 2008. Journal of Animal and Feed Science 17, 120-36.
7. Simon, A., Schwabe, M., Bergner, H., (1997). Glycerol supplementation to broiler rations with low crude protein content. Archives in Animal Nutrition 50:271-282.
8. Final Report—“Sterility testing and antimicrobial activity of commercial grade glycerine”, Prepared for Joyce C. Kern, Manager Glycerine Producers' Association 475 Park Avenue South New York, N.Y. By Warren Litsky Christopher J. Libbey and Eugene J. Ivlariani, Jr., University of Massachusetts, Amherst, Mass. 01002 (August 1971).
9. “Glycerol: A Jack Of All Trades” by Mary Ann David, George S. Henry Academy, North York (Toronto), Ontario.
10. “Glycerol as a Feed Ingredient in Dairy Rations” by Shawn S. Donkin and Perry Doane, Department of Animal Sciences Purdue University, Tri-State Dairy Nutrition Conference (April 2007).
11. “Food chain mycotoxins 2010: Treats and solutions” by D. Brown, Department of Animal Science, Cornell University and references therein.
12. “Methods to reduce mycotoxins in animal feeds” by G. Avantaggiato, Institute of Sciences of Food Production, ISPA-CNR, Italy (September 2009).
13. Cameron, E. K. and Patten, H. E., J. Phys. Chem. 15. 67-72 (1911).
14. “Purification of propylene oxide by treatment with calcium hydroxide in glycerol or sugar water”, Patent 4691034 Issued on Sep. 1, 1987. Estimated Expiration Date: Apr. 14, 2006.
15. Solubilities of Inorganic And Metal Organic Compounds, 3rd ed. by A. Seidell, D. Van Nostrand Co., Inc., New York, 1940, Vol. 1, pp. 315 to 318.
16. Villarreal, M. E., et al., J. Food Protection 53: 465-467 (1990).
17. Brown rot of stone fruits, Ministry of Agriculture, Canada (2007).
18. The pectic compounds and pectic enzymes by J W Deacon, Modern Mycology, Blackwell Science (1997).
19. Mycotoxin Testing and Sampling of Poultry Feed Ingredients by Victoria Siegel, Feed Laboratory: Mycotoxins, Drugs and Vitamins, Purdue University, W. Lafayette Ind., USA, Presentation given at the 2011 Midwest Poultry Federation Convention, held in St. Paul, Minn., USA (16-17 Mar. 2011).
20. Interventions to Reduce Foodborne Pathogens in Poultry and Livestock by M. C. Erickson and M. P. Doyle, Center for Food Safety, University of Georgia, USA (2008) and references therein.
21. Renal Failure and Losses of Ca²⁺, PO₄³⁻ and Na⁺ by Chronic Ingestions of Aflatoxin in laying hens by A. Martinez-de-Anda, A. G. Valdivia and F. Jaramillo-Juárez, Aguascalientes Autonomous University, Mexico; J. L. Reyes—National Polytechnic Institute, Mexico (2011).
22. Feeding Vomitoxin (DON)-contaminated Feed to Poultry: What has changed? by Swamy Haladi, Alltech Canada, Guelph, ON, Canada, presented at the 2010 Multi-State Poultry Feeding & Nutrition Conference, Indianapolis, Ind., USA (2010) and references therein.
23. Fusarium mycotoxins in UK straw from the 2008 harvest—implications for pigs on straw bedding, S. G. Edwards and A. H. Stewart, presented to the British Society of Animal Science Annual Conference, Queens's University, Belfast (April 2010).

1. Use of a treatment composition for preventing, or reducing, the production of contaminants selected from microorganisms and microorganism-produced toxins by contacting the substrate with the composition, the composition including a water glycerol mixture and calcium hydroxide, the percentage by mass of glycerol in the water glycerol mixture being between 5% and 95%, at least some of the calcium hydroxide being dissolved in the water glycerol mixture and the concentration of the dissolved calcium hydroxide in the water glycerol mixture being at least 1.5 times higher than the maximum concentration of dissolved calcium hydroxide which can be obtained in water alone, thereby preventing or reducing the production of the contaminants, the extent of the prevention or reduction being at least 1.5 times more than the corresponding prevention or reduction produced by a treatment composition comprising water and calcium hydroxide only.

2. Use as claimed in claim 1, in which the percentage by mass of glycerol in the water glycerol mixture is 20% or more and the concentration of the dissolved calcium hydroxide in the water glycerol mixture is at least 3 times higher than the maximum concentration of dissolved calcium hydroxide which can be obtained in water alone.

3. Use as claimed in claim 2, in which the percentage by mass of glycerol in the water glycerol mixture is 50% or more and the concentration of the dissolved calcium hydroxide in the water glycerol mixture is at least 10 times higher than the maximum concentration of dissolved calcium hydroxide which can be obtained in water alone.

4. Use as claimed in any one of the preceding claims, in which the percentage by mass of glycerol in the water glycerol mixture is between 15% and 80% and the corresponding extent of the prevention or reduction is between 2 and 15 times more than the corresponding prevention or reduction produced by a treatment composition comprising water and solubilised hydroxide only.

5. Use as claimed in any one of the preceding claims, in which the microorganisms include moulds and the microorganism-produced toxins are selected from mycotoxins and endotoxins.

6. Use as claimed in any one of the preceding claims, in which the treatment composition is produced from materials selected from solid glycerol-derived materials and semi-solid glycerol-derived materials, the solid materials being selected from powders, granules and flakes and the semi-solid materials being selected from pastes, slurries, emulsions and suspensions.

7. Use as claimed in claim 6, in which the glycerol-derived material is produced by methods selected from reacting glycerol, water and a base selected from calcium oxide or a mixture of calcium oxide and calcium hydroxide in an exothermic reaction to produce the glycerol-derived material or by combining wet or dry glycerol and a base selected from calcium oxide, a mixture of calcium oxide and calcium hydroxide or calcium hydroxide and optionally drying the product to produce the glycerol-derived material.

8. Use as claimed in any one of the preceding claims, in which the substrate is an animal feed or an animal feed product.

9. Use as claimed in any one of claims 1 to 7 inclusive, in which the substrate is a food product selected from fruit, vegetables, grains, seeds, nuts, herbs, spices, salad ingredients, carcasses, meat, meat-derived products, fish, fish-derived products and eggs.

10. Use as claimed in any one of claims 1 to 7 inclusive, in which the substrate is animal bedding material.

11. Use as claimed in any one of claims 1 to 7 inclusive, in which the substrate is an animal or a human.

12. Use as claimed in any one of the preceding claims, in which contacting the substrate with the composition is by a method selected from mixing, blending, dipping, spraying, misting, fogging or painting the substrate with the composition or applying the composition to the substrate with or without adding water to the substrate.

13. A treatment composition for preventing, or reducing, the production of contaminants selected from microorganisms and microorganism-produced toxins, the composition including a water glycerol mixture and calcium hydroxide, the percentage by mass of glycerol in the water glycerol mixture being between 5% and 95%, at least some of the calcium hydroxide being dissolved in the water glycerol mixture and the concentration of the dissolved calcium hydroxide in the water glycerol mixture being at least 1.5 times higher than the maximum concentration of dissolved calcium hydroxide which can be obtained in water alone.

14. A treatment composition as claimed in claim 13, in which the percentage by mass of glycerol in the water glycerol mixture is 20% or more and the concentration of the dissolved calcium hydroxide in the water glycerol mixture is at least 3 times higher than the maximum concentration of dissolved calcium hydroxide which can be obtained in water alone.

15. A treatment composition as claimed in claim 14, in which the percentage by mass of glycerol in the water glycerol mixture is 50% or more and the concentration of the dissolved calcium hydroxide in the water glycerol mixture is at least 10 times higher than the maximum concentration of calcium hydroxide which can be obtained in water alone.

16. An agent selected from household cleaning agents, industrial cleaning agents, sanitizing agents and disinfecting agents comprising a composition as claimed in any one of claims 13 to 15 inclusive.
